(19) United States
(12) Patent Application Publication
(10) Pub. No.: US 2026/0236949 A1
(43) Pub. Date: Aug. 13, 2026

(54) INFORMATION PROCESSING SYSTEM, INFORMATION PROCESSING METHOD, AND NON-TRANSITORY COMPUTER READABLE MEDIUM

(71) Applicant: NEC Corporation, Tokyo (JP)

(72) Inventors: Daiki YOSHIHARA, Tokyo (JP); Takumi OZAKI, Tokyo (JP); Jianquan LIU, Tokyo (JP); Takayuki KASE, Tokyo (JP); Noboru YOSHIDA, Tokyo (JP)

(73) Assignee: NEC Corporation, Tokyo (JP)

(21) Appl. No.: 19/154,515

(22) PCT Filed: Feb. 9, 2024
(86) PCT No.: PCT/JP2024/004499

§ 371 Date: Aug. 7, 2025

(30) Foreign Application Priority Data
Feb. 16, 2023 (JP) 2023-022231

(51) Int. Cl. G06Q 30/0201

(52) U.S. Cl. CPC G06Q 30/02011

(57) ABSTRACT

This information processing system comprises an attribute identifying unit and a statistical processing unit. The attribute identifying unit processes a video relating to a facility to identify a plurality of attributes relating to each of a plurality of customers. The statistical processing unit uses at least one attribute included in the identified plurality of attributes to perform statistical processing relating to the plurality of customers. The at least one attribute includes a group activity attribute relating to customers who act in groups of a plurality of people.

### TECHNICAL FIELD

The present invention relates to an information processing system, an information processing method, and a recording medium.

### BACKGROUND ART

For example, PTL 1 discloses an aggregation system capable of aggregating characteristics of non-users who did not engage in a predetermined use among visitors at a predetermined location. For example, PTL 2 discloses a system that calculates the number of people staying on each floor of the building for each attribute of a person.

PTL 3 describes a technology for calculating features of each of a plurality of human body keypoints included in an image, searching for images including human bodies with similar postures or similar movements based on the calculated features, and collectively classifying the images by the human bodies with similar posture or movement.

### CITATION LIST

### Patent Literature

PTL 1: WO 2009/041242 A1

PTL 2: JP 2017-218248 A

PTL 3: WO 2021/084677 A1

### SUMMARY OF INVENTION

### Technical Problem

In general facilities, some customers act in groups of a plurality of people, and some customers act alone. Depending on whether the customers act in a group or act alone, there may be a difference in activity of a customer in the facility, such as a purchasing activity.

However, PTLs 1 and 2 do not disclose a technology for distinguishing whether a customer performs a group activity or a customer performs an individual activity, and it is difficult to identify the activity of the customer in a facility according to this distinction. PTL 3 also does not disclose a technology for distinguishing whether a customer performs a group activity or a customer performs an individual activity.

In view of the above-described problems, an object of the present invention is to provide an information processing system, an information processing method, a program, a recording medium, and the like capable of identifying an activity of a customer in a facility depending on whether a customer performs a group activity or a customer performs an individual activity.

### Solution to Problem

According to an aspect of the present invention, there is provided an information processing system including:
an attribute identification means for processing a video relating to a facility to identify a plurality of attributes relating to each of a plurality of customers; and
a statistical processing means for performing statistical processing relating to the plurality of customers by using at least one attribute included in the identified plurality of attributes,
in which the at least one attribute includes a group activity attribute relating to customers who act in groups of a plurality of people.

According to another aspect of the present invention, there is provided an information processing method including causing one or more computers to:
process a video relating to a facility to identify a plurality of attributes relating to each of a plurality of customers; and
perform statistical processing relating to the plurality of customers by using at least one attribute included in the identified plurality of attributes,
in which the at least one attribute includes a group activity attribute relating to customers who act in groups of a plurality of people.

According to still another aspect of the present invention, there is provided a recording medium that stores a program for causing one or more computers to execute processing of:
processing a video relating to a facility to identify a plurality of attributes relating to each of a plurality of customers; and
performing statistical processing relating to the plurality of customers by using at least one attribute included in the identified plurality of attributes,
in which the at least one attribute includes a group activity attribute relating to customers who act in groups of a plurality of people.

### Advantageous Effects of Invention

According to the aspects of the present invention, it is possible to identify the activity of the customer in the facility according to whether a customer performs a group activity or a customer performs an individual activity.

### BRIEF DESCRIPTION OF DRAWINGS

FIG. 1 is a diagram illustrating an outline of an information processing system according to a first example embodiment.

FIG. 2 is a diagram illustrating an outline of an information processing method according to the first example embodiment.

FIG. 3 is a diagram illustrating a configuration example of an information processing system according to the first example embodiment.

FIG. 4 is a diagram illustrating a functional configuration example of a video analysis device according to the first example embodiment.

FIG. 5 is a diagram illustrating a functional configuration example of an attribute identification unit according to the first example embodiment.

FIG. 6 is a diagram illustrating a functional configuration example of a statistical processing device according to the first example embodiment.

FIG. 7 is a diagram illustrating a physical configuration example of a video analysis device according to the first example embodiment.

FIG. 8 is a flowchart illustrating an example of video analysis processing according to the first example embodiment.

FIG. 9 is a flowchart illustrating an example of customer statistical processing according to the first example embodiment.

FIG. 10 is a diagram illustrating a functional configuration example of a video analysis device according to a second example embodiment.

FIG. 11 is a diagram illustrating a functional configuration example of an attribute identification unit according to the second example embodiment.

FIG. 12 is a flowchart illustrating an example of video analysis processing according to the second example embodiment.

FIG. 13 is a diagram illustrating a functional configuration example of a video analysis device according to a third example embodiment.

FIG. 14 is a diagram illustrating a functional configuration example of an attribute identification unit according to the third example embodiment.

FIG. 15 is a flowchart illustrating an example of video analysis processing according to the third example embodiment.

### EXAMPLE EMBODIMENT

Hereinafter, example embodiments of the present invention will be described with reference to the drawings. In all the drawings, the same components are denoted by the same reference numerals, and the description thereof will be omitted as appropriate.

### <First Example Embodiment

### (Outline)

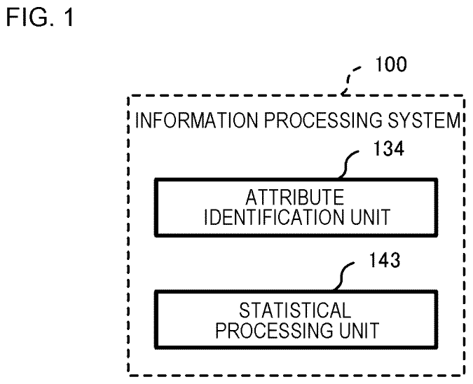

FIG. 1 is a diagram illustrating an outline of an information processing system 100 according to a first example embodiment. This information processing system 100 includes an attribute identification unit 134 and a statistical processing unit 143. The attribute identification unit 134 processes a video relating to a facility to identify a plurality of attributes relating to each of a plurality of customers. The statistical processing unit 143 uses at least one attribute included in the identified plurality of attributes to perform statistical processing relating to a plurality of customers. The at least one attribute includes a group activity attribute relating to customers who act in groups of a plurality of people.

In the information processing system 100, it is possible to identify the activity of the customer in a facility according to whether a customer performs a group activity or a customer performs an individual activity.

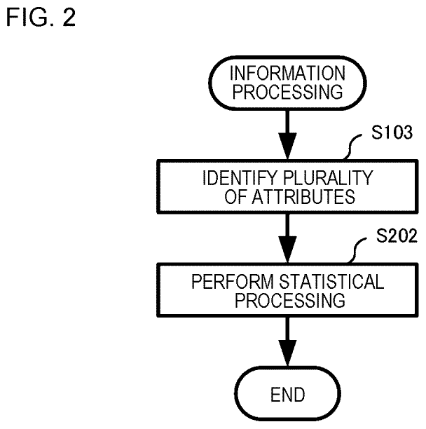

FIG. 2 is a diagram illustrating an outline of an information processing method according to the first example embodiment. The information processing method includes causing one or more computers to process a video relating to a facility to identify a plurality of attributes relating to each of a plurality of customers (step S103), and perform statistical processing relating to the plurality of customers by using at least one attribute included in the identified plurality of attributes. The at least one attribute includes a group activity attribute relating to customers who act in groups of a plurality of people.

In the information processing method, it is possible to identify the activity of the customer in a facility according to whether a customer performs a group activity or a customer performs an individual activity.

Hereinafter, a detailed example of the information processing system 100 according to the first example embodiment will be described.

### (Details)

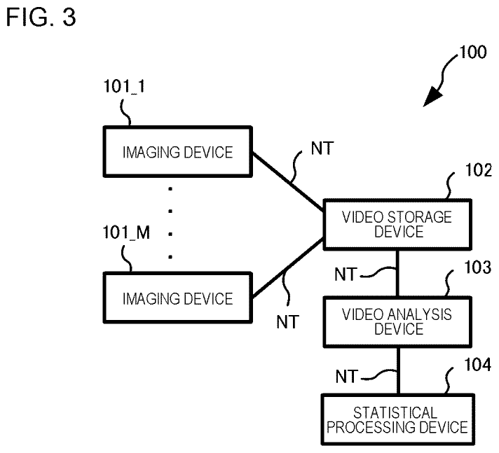

FIG. 3 is a diagram illustrating the configuration example of the information processing system 100 according to the first example embodiment. The information processing system 100 is a system that processes a video relating to a facility to identify a plurality of attributes relating to each of a plurality of customers included in the video.

The facility is, for example, a store such as a convenience store or a supermarket, a department store, a multi-purpose commercial facility, or the like, but is not limited thereto.

The information processing system 100 includes, for example, one or more imaging devices 101_1 to 101_M (M is an integer equal to or more than one), a video storage device 102, a video analysis device 103, and a statistical processing device 104.

The imaging devices 101_1 to 101_M, the video storage device 102, the video analysis device 103, and the statistical processing device 104 are connected to each other via a network NT, and transmit and receive information to and from each other via the network NT. The network NT may include a communication line that is wired, wireless, or an appropriate combination thereof, a device (not illustrated) that relays information, or the like.

(Imaging devices 101_1 to 101_M according to first example embodiment) Each of the imaging devices 101_1 to 101_M is, for example, a camera. Each of the imaging devices 101_1 to 101_M is installed in or around a facility in such a way as to capture an image of the imaging area relating to the facility. Each of the imaging devices 101_1 to 101_M generates a video obtained by capturing the image of the imaging area. The video is, for example, a moving image including a plurality of frame images.

The imaging area relating to the facility includes, for example, an entrance/exit of the facility, an area through which a customer passes in the facility, a parking lot provided on a site of the facility, and a predetermined range from a payment device (so-called cash register) of the facility.

The entrance/exit is used as not only both an exit from a facility and an entrance to a facility, but also as only an exit from a facility and as only an entrance to a facility. The predetermined range from the payment device includes, for example, an area where customers line up for payment.

The imaging devices 101_1 to 101_M transmit the generated video to, for example, the video storage device 102. Each of the imaging devices 101_1 to 101_M may transmit the video in real time. Each of the imaging devices 101_1 to 101_M may store the captured video and transmit the video captured during a period corresponding to a predetermined transmission time, or may receive a request and transmit the video captured during a period corresponding to the request. For example, this request may be transmitted from any one of the video storage device 102, the video analysis device 103, the statistical processing device 104, and the like based on a user's input.

The period corresponding to the transmission time is, for example, a period from the previous transmission time to the current transmission time. The period corresponding to the request may be a period designated by the request, or may be a period from the previous request to the current request.

The imaging devices 101_1 to 101_M may transmit the captured video to the video storage device 102 or transmit the captured video to the video analysis device 103 instead of transmitting the captured video to the video storage device 102. A timing at which the imaging devices 101_1 to 101_M transmit the video and which period of captured image is to be transmitted at the transmission time are not limited thereto.

### (Regarding Functional Configuration of Video Storage Device 102 According to First Example Embodiment)

The video storage device 102 is an information processing device that acquires a video captured by each of the imaging devices 101_1 to 101_M and stores the acquired video. The video storage device 102 transmits the stored video to, for example, the video analysis device 103.

The video storage device 102 may receive a request based on the user's input to the video analysis device 103, the statistical processing device 104, or the like, and transmit the video captured during a period corresponding to the request. The period corresponding to the request may be a period designated by the request, or may be a period from the previous request to the current request.

A timing at which the video storage device 102 transmits the video and which period of captured image is to be transmitted at the transmission time are not limited thereto. For example, the video storage device 102 may transmit the video in real time. For example, the video storage device 102 may transmit the video captured during a period corresponding to a predetermined transmission time. The period corresponding to the transmission time is, for example, a period from the previous transmission time to the current transmission time.

### (Regarding Functional Configuration of Video Analysis Device 103 According to First Example Embodiment)

The video analysis device 103 is an information processing device that processes a video captured by each of the imaging devices 101_1 to 101_M, that is, a video relating to a facility, and identifies a plurality of attributes relating to each of a plurality of customers included in the video.

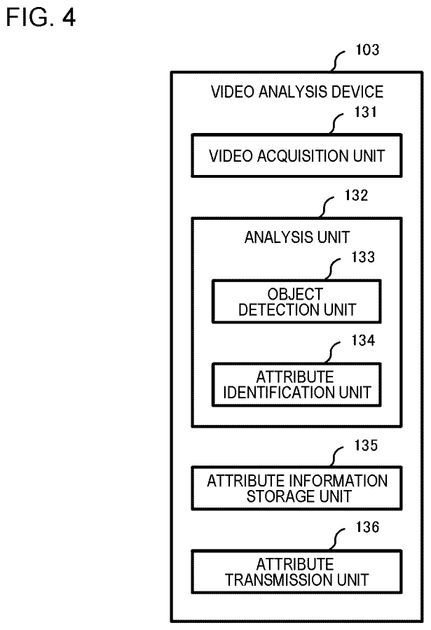

FIG. 4 is a diagram illustrating the functional configuration example of the video analysis device 103 according to the first example embodiment. The video analysis device 103 functionally includes, for example, a video acquisition unit 131, an analysis unit 132 including an object detection unit 133 and an attribute identification unit 134, an attribute information storage unit 135, and an attribute transmission unit 136.

The video acquisition unit 131 acquires a video from the video storage device 102. For example, the video acquisition unit 131 may acquire the video from each of the imaging devices 101_1 to 101_M in real time.

When the video acquisition unit 131 acquires the video, the analysis unit 132 detects an object included in the video by processing the video, and identifies an attribute of the detected object. The object includes a person and an object.

The analysis unit 132 has one or more analysis functions for processing and analyzing the video. The analysis unit 111 has one or more analysis functions, for example, (1) an object detection function, (2) a facial analysis function, (3) a human figure analysis function, (4) a posture analysis function, (5) an activity analysis function, (6) an appearance attribute analysis function, (7) a gradient feature analysis function, (8) a color feature analysis function, and (9) a movement path analysis function.
(1) the object detection function detects an object from an image. The object detection function may also obtain the position of the object in the image. Examples of a model applied to the object detection processing include YOLO (You Only Look Once).

The person detected by the object detection function includes, for example, a customer. The object detected by the object detection function includes, for example, baggage carried by a person and an automobile, a bicycle, a two-wheeled vehicle, or the like as a visiting means used for a person to visit a facility. The object detected by the object detection function may include, for example, a payment device, a delivery box, an ATM, an object constituting an entrance/exit of a facility, and an object constituting an entrance/exit of a toilet. For example, the object detection function obtains the positions of these objects in the image.
(2) The facial analysis function detects a person's face from an image, extracts features (facial features) of the detected face, classifies the detected face, and the like. The facial analysis function can also obtain the position of the face in the image. The facial analysis function can also determine the identity of the people detected from the different images based on the similarity between the facial features of the people detected from the different images.
(3) The human figure analysis function extracts a human body features (for example, values indicating overall characteristics such as body build (slim or heavy build), height, and clothing) included in the image, and classifies the person included in the image. The human figure analysis function can also identify the position of the person in the image. The human figure analysis function can also determine the identity of the people included in the different images based on the human body features of the people included in the different images.
(4) The posture analysis function detects joint points of a person from the image and creates a stick figure model formed by connecting the joint points. The posture analysis function estimates the posture of the person using the information of the stick figure model, extracts the features (posture features) of the estimated posture, and classifies the person included in the image. The posture analysis function can also determine the identity of the people included in the different images based on the human body features of the people included in the different images.

For example, the technology disclosed in PTL 3 can be applied to the posture analysis function.
(5) The activity analysis processing can estimate the movement of the person using the information of the stick figure model, a change in the posture, and the like, extract the features (movement features) of the movement of the person, and classify the person included in the image. In the activity analysis processing, the height of the person can be estimated or the position of the person in the image can be identified using the information of the stick figure model. In the activity analysis processing, for example, an activity such as a change or transition in a posture or movement (a change or transition in a position) can be estimated from the image, and the movement features of the activity can be extracted.
(6) The appearance attribute analysis function can recognize an appearance attribute associated with a person. The appearance attribute analysis function extracts features (appearance attribute features) relating to the recognized appearance attribute, classifies a person included in the image, and the like. The appearance attribute is an attribute in appearance of a person. The appearance attribute includes, for example, one or more of age group, gender, type of clothing, color and pattern, type of shoes, color and pattern, hairstyle, wearing or not wearing a hat, wearing or not wearing a necktie, or wearing or not wearing glasses. The type of clothing includes, for example, one or more of a workwear, a uniform, or a suit.
(7) The gradient feature analysis function extracts features (gradient features) of a gradient in an image. For example, technologies such as SIFT, SURF, RIFF, ORB, BRISK, CARD, and HOG can be applied to gradient feature detection processing. SIFT is an abbreviation for Scale-InvariantFeature Transform. SURF is an abbreviation for Speeded-Up Robust Features. RIFF is an abbreviation for Rotation-Invariant Fast Feature. BRIEF is an abbreviation for Binary Robust Independent Elementary Features. ORB is an abbreviation for Oriented FAST and Rotated BRIEF. BRISK is an abbreviation for Binary Robust Invariant Scalable Keypoints. CARD is an abbreviation for Compact And Real-time Descriptors. HOG is an abbreviation for Histograms of Oriented Gradients.
(8) The color feature analysis function can detect an object from an image, extract features (color features) of a color of the detected object, classify the detected object, and the like. The color features include, for example, a color histogram.
(9) The movement path analysis function can obtain a movement path (trajectory of movement) of a person included in a video, for example, by using a result of identity determination in any of the analysis functions (2) to (6) described above. Specifically, for example, by connecting instances of a person determined to be the same in the different images obtained in time series, the movement path of the person can be obtained. The movement path analysis function can also obtain a movement path across a plurality of videos obtained by capturing different imaging areas in a case where the videos captured by a plurality of the imaging devices 101 that capture different imaging areas are acquired.

The analysis unit 132 detects an object included in the video using, for example, the above-described analysis functions (1) to (9), and identifies an attribute of the detected object. The analysis unit 132 can also identify other attributes using the specified one or more attributes. The analysis unit 132 is not limited to the above-described analysis functions (1) to (9), and may include an analysis function used in general image processing, image recognition, and the like.

In the present example embodiment, such an analysis unit 132 functionally includes, for example, the object detection unit 133 and the attribute identification unit 134.

The object detection unit 133 processes a video relating to the facility and detects at least a customer which is an object included in the video. The object detection unit 133 may detect an item which is an object included in the video. The object detection unit 133 generates attribute information including customer identification information for identifying a plurality of the detected customers, for example, based on a detection result. The object detection unit 133 may further include item identification information for identifying a plurality of detected items in the attribute information based on the detection result.

The attribute identification unit 134 processes a video relating to a facility to identify a plurality of attributes relating to each of a plurality of customers included in the video. The attribute identification unit 134 generates attribute information including a plurality of attributes for each of a plurality of customers. The attribute information is, for example, information that associates a plurality of customers included in a video relating to a facility with a plurality of attributes identified for each of the plurality of customers for each customer.

The attribute to be used for each attribute relating to the customer may be appropriately predetermined.

Examples of how to represent the attribute include a code and a numerical value predetermined for the attribute. The code for representing the attribute is suitable for an attribute in which aspects, properties, and the like of a plurality of features corresponding to the attribute are predetermined, such as gender, age group, and the like. The code may be, for example, any one of a number, an alphabetic character, a symbol, and the like, and one or more thereof may be combined in any number and order. The numerical value for representing the attribute is suitable for an attribute represented by a continuous numerical value corresponding to magnitude, degree, or the like, for example, a position, a distance, and the like.

As an example of how to represent the attribute, identification information for identifying the attribute can be exemplified. The identification information for representing the attribute is suitable for identifying an attribute that is difficult to determine in advance, such as each person and each object, and may include, for example, the above-described code appropriately assigned according to the attribute.

How to represent each attribute is not limited thereto.

An example of a plurality of attributes and an example of how to represent various attributes according to the present example embodiment will be described below. The plurality of attributes and how to represent each attribute according to the present example embodiment are not limited to the following examples.

In the present example embodiment, the plurality of attributes include, for example, (1) An individual/group activity attribute. The plurality of attributes may further include, for example, at least one of (2) a purchase/non-purchase attribute, (3) a utilization equipment attribute, or the like.
(1) Example of individual/group activity attribute (including group activity attribute)

The individual/group activity attribute is an attribute of the customer regarding whether the customer is an individual customer or a group customer. The individual customer is a customer who acts alone. The group customer refers to customers who act in groups of a plurality of people.

The individual/group activity attribute includes a group activity attribute relating to a group customer. The individual/group activity attribute may further include an individual activity attribute relating to an individual customer. That is, a plurality of attributes are only required to include at least the group activity attribute.

In the present example embodiment, the individual/group activity attribute is represented by a code “zero” and group identification information respectively associated with the individual customer and the group customer. In this case, the code “zero” for the individual/group activity attribute is an example of the attribute indicating the individual customer, that is, the individual activity attribute. The group identification information is identification information for identifying a group to which the customer belongs. The group identification information is an example of an attribute indicating the group customer, that is, the group activity attribute. By setting the group identification information to the group activity attribute, it is possible to indicate that a customer is a group customer and identify a group to which the customer belongs.

In a case where it is not necessary to identify the group, the group activity attribute may be represented using a code (for example, “zero” indicating that the customer is not a group customer but is an individual customer and “one” indicating that the customer is a group customer) indicating whether the customer is a group customer. A plurality of attributes may respectively include the individual activity attribute and the group activity attribute. At least one of the individual activity attribute or the group activity attribute configured individually may be included as an element of a plurality of attributes without using the individual/group activity attribute including them. The individual activity attribute in this case may be represented using, for example, a code (for example, “zero” and “one”) indicating whether the customer is an individual customer. The group activity attribute in this case may be represented using, for example, a code indicating whether the customer is a group customer, group identification information, or the like. Similarly to the attributes other than the individual/group activity attribute, the attribute itself including a plurality of attributes may not be included in a plurality of attributes, and the attribute subordinate thereto may be included as an element of a plurality of attributes.
(2) Example of purchase/non-purchase attribute (including non-purchase attribute) The purchase/non-purchase attribute is an attribute relating to whether the customer is a purchasing customer or a non-purchasing customer. The purchasing customer is a customer who has purchased a product in a facility. The non-purchasing customer is a customer who does not purchase a product in a facility.

The purchase/non-purchase attribute includes at least one of a purchase attribute or a non-purchase attribute. The purchase attribute is an attribute indicating a purchasing customer. The non-purchase attribute is an attribute indicating a non-purchasing customer.

In the present example embodiment, the purchase/non-purchase attribute is represented by two codes “zero” and “one” respectively predetermined in association with the purchasing customer and the non-purchasing customer. In this case, “zero” for the purchase/non-purchase attribute is an example of the purchase attribute. In this case, “one” for the purchase/non-purchase attribute is an example of the non-purchase attribute.
(3) The utilization equipment attribute is an attribute relating to the equipment of a facility used by a customer. The equipment of the facility is equipment provided in the facility, and includes, for example, at least one of a toilet, a delivery box, an automated teller machine (ATM), or the like. The equipment of the facility is not limited thereto, and may be, for example, a store in the facility in a case where the facility is a multi-purpose commercial facility.

In the present example embodiment, the utilization equipment attribute will be described using an example represented by a code “zero” predetermined in association with a customer in a case where the customer does not use equipment, and a code predetermined in association with the type of equipment used by the customer. Specifically, in the present example embodiment, the description will be made using the example in which the type of equipment is a toilet, a delivery box, or an ATM, and codes “one”, “two”, and “three” are predetermined in association with each other.

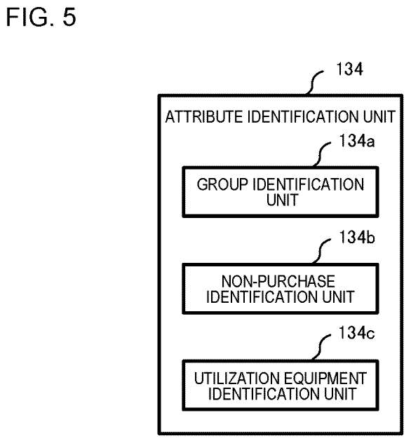

FIG. 5 is a diagram illustrating a functional configuration example of the attribute identification unit 134 according to the first example embodiment. The attribute identification unit 134 functionally includes, for example, a group identification unit 134a, a non-purchase identification unit 134b, and a utilization equipment identification unit 134c.

For example, the group identification unit 134a processes a video relating to a facility to identify a group activity attribute relating to each of a plurality of customers included in the video. The group identification unit 134a associates, for example, an individual/group activity attribute with each of a plurality of customers included in the attribute information based on the identification result.

In the present example embodiment, for example, a code “zero” corresponding to the individual customer is set to the initial value of the detected individual/group activity attribute relating to the customer. The group identification unit 134a processes a video relating to a facility to identify a group customer among a plurality of the detected customers. The group identification unit 134a sets a code “one” corresponding to the group customer to the individual/group activity attribute relating to the identified group customer.

The group identification unit 134a is only required to be able to identify the group activity attribute. The method in which the group identification unit 134a identifies the group activity attribute is not limited to the example described here. The code “one” corresponding to the group customer may be set to the initial value of the individual/group activity attribute relating to the customer, and the group identification unit 134a may identify the individual customer among a plurality of customers and set the code “zero” to the individual/group activity attribute relating to the individual customer.

For example, the non-purchase identification unit 134b processes a video relating to a facility to identify a non-purchase attribute relating to each of a plurality of customers included in the video. The non-purchase identification unit 134b associates, for example, a purchase/non-purchase attribute with each of a plurality of customers included in the attribute information based on the identification result.

In the present example embodiment, for example, a code “one” corresponding to the non-purchasing customer is set to the initial value of the detected purchase/non-purchase attribute relating to the customer. The non-purchase identification unit 134b processes a video relating to a facility to identify a purchasing customer among a plurality of the detected customers. The non-purchase identification unit 134b sets the code “zero” corresponding to the purchasing customer to the purchase/non-purchase attribute relating to the identified purchasing customer.

The non-purchase identification unit 134b is only required to be able to identify the non-purchase attribute. The method in which the non-purchase identification unit 134b identifies the non-purchase attribute is not limited to the example described here. The code “zero” corresponding to the purchasing customer may be set to the initial value of the purchase/non-purchase attribute, and the group identification unit 134a may identify the non-purchasing customer among a plurality of customers and set the code “one” to the purchase/non-purchase attribute relating to the non-purchasing customer.

For example, the utilization equipment identification unit 134c processes a video relating to a facility to identify a utilization equipment attribute relating to each of a plurality of customers included in the video. The utilization equipment identification unit 134c associates a utilization equipment attribute with each of a plurality of customers included in the attribute information based on the identification result.

In the present example embodiment, for example, a code “zero” corresponding to a customer who does not use the equipment is set to the initial value of the detected utilization equipment attribute relating to the customer. The utilization equipment identification unit 134c processes a video relating to a facility, identifies the customer who has used the equipment among a plurality of the detected customers, and identifies the equipment used.

In order to identify the customer who has used the equipment and the equipment used, for example, the utilization equipment identification unit 134c may hold in advance equipment information indicating the arrangement of the equipment in the facility. By using the position of the customer obtained by processing the video and the held equipment information, the utilization equipment identification unit 134c may identify whether the customer uses the equipment and identify the equipment in a case where the customer has used the equipment (for example, the type of equipment).

The utilization equipment identification unit 134c sets one of codes “one”, “two”, and “three” corresponding to the type of equipment used to the utilization equipment attribute relating to the customer who uses the equipment. In a case where a customer has used a plurality of types of equipment, the utilization equipment identification unit 134c may set a plurality of codes respectively corresponding to a plurality of types of equipment used by the customer to the utilization equipment attribute relating to the customer.

The method in which the utilization equipment identification unit 134c identifies the utilization equipment attribute is not limited thereto.

The attribute identification unit 134 includes a group identification unit 134a, a non-purchase identification unit 134b, and a utilization equipment identification unit 134c, which are identification units for identifying each of such a plurality of attributes. Thus, the attribute identification unit 134 can generate attribute information in which the individual/group activity attribute, the purchase/non-purchase attribute, and the utilization equipment attribute, which are a plurality of attributes identified by each identification unit, are associated with each of a plurality of detected customers.

Reference is made again to FIG. 4.

The attribute information storage unit 135 is a storage unit for storing the attribute information. For example, the attribute identification unit 134 stores the generated attribute information in the attribute information storage unit 135.

The attribute transmission unit 136 transmits the attribute information generated by the attribute identification unit 134. The attribute transmission unit 136 transmits, for example, the attribute information stored in the attribute information storage unit 135 to the statistical processing device 104.

### (Regarding Functional Configuration of Statistical Processing Device 104 According to First Example Embodiment)

The statistical processing device 104 is an information processing device that performs statistical processing relating to a plurality of customers included in a video relating to a facility by using attribute information. The statistical processing device 104 may perform the statistical processing on a plurality of customers included in the video relating to the facility by using the attribute information and at least one attribute included in a plurality of attributes. The at least one attribute used for the statistical processing may include a group activity attribute.

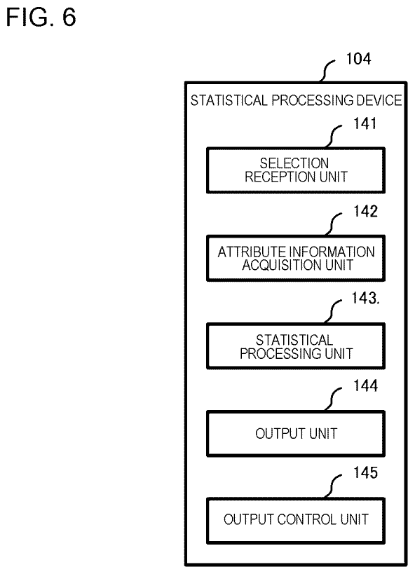

FIG. 6 is a diagram illustrating a functional configuration example of the statistical processing device 104 according to the first example embodiment. The statistical processing device 104 functionally includes, for example, a selection reception unit 141, an attribute information acquisition unit 142, a statistical processing unit 143, an output unit 144, and an output control unit 145.

The selection reception unit 141 receives selection information indicating a setting selected for statistical processing using the attribute information.

The selection information includes a statistical processing attribute group including at least one attribute used for statistical processing. The statistical processing attribute group may include at least one of a plurality of attributes identified for each of a plurality of customers.

In the present example embodiment, the statistical processing attribute group includes at least one attribute selected from a plurality of attributes included in the attribute information acquired by the attribute information acquisition unit 142. Specifically, for example, the statistical processing attribute group may include at least one of (1) an individual/group activity attribute including at least a group activity attribute, (2) a purchase/non-purchase attribute including at least one of a purchase attribute or a non-purchase attribute, or (3) a utilization equipment attribute.

The selection information may further include a target time to be subjected to the statistical processing, a statistical processing method as to how to perform the statistical processing using the attribute, and a setting relating to a format of a figure used to represent a result of the statistical processing.

The target time is, for example, a period such as a selected time period, date, or month. A selection time is not limited thereto, and may be, for example, a time point such as a selected time.

The statistical processing method includes, for example, aggregating the number of customers corresponding to one attribute or a combination of a plurality of attributes, and obtaining a ratio of the number of customers. In the case of obtaining the ratio, the statistical processing method may include an attribute for aggregating the number of customers used as the statistical parameter.

The statistical processing method may include, for example, classification indicating whether to perform time-series processing for the target time or to perform processing for the entire target time. In a case where the time-series processing is performed, the statistical processing method may include a time interval for performing the time-series processing. A general statistical method may be used for the statistical processing, and the statistical processing method is not limited thereto.

The format of the figure is, for example, a line graph, a pie chart, a bar graph, or the like. The format of the figure is not limited thereto.

The attribute information acquisition unit 142 acquires the attribute information generated by the video analysis device 103. For example, the attribute information acquisition unit 142 acquires attribute information generated based on a video captured at the target time.

The statistical processing unit 143 performs statistical processing regarding a plurality of customers included in the video relating to the facility by using at least one attribute included in a plurality of attributes identified for each of the plurality of customers. The statistical processing unit 143 generates a result of the statistical processing.

For example, the statistical processing unit 143 performs the statistical processing by using the attribute information acquired by the attribute information acquisition unit 142 and the selection information received by the selection reception unit 141. The result of the statistical processing may include at least one of a numerical value generated in the statistical processing or a figure indicating the numerical value in a format included in the selection information. The result of the statistical processing is not limited thereto.

In the present example embodiment, as described above, the statistical processing attribute group includes at least one of (1) an individual/group activity attribute including at least a group activity attribute, (2) a purchase/non-purchase attribute including at least one of a purchase attribute or a non-purchase attribute, or (3) a utilization equipment attribute.

By using such an attribute, for example, the statistical processing unit 143 may obtain the respective ratios of the purchasing customer and the non-purchasing customer among the group customers. For example, the statistical processing unit 143 may obtain the number of non-purchasing customers aggregated for each of a plurality of attributes or a ratio of the aggregated number of customers to the number of non-purchasing customers. A plurality of attributes in this case may include a group activity attribute.

For example, the statistical processing unit 143 may aggregate the customers who have used the equipment for each type of equipment, and may obtain the number of customers who have used the equipment or the ratio of the number of customers for each type of equipment used to all the customers. The customer who has used the equipment here may be a customer belonging to another attribute such as a group customer or a non-purchasing customer. For example, the statistical processing unit 143 may obtain a ratio of customer for another attribute to customer who has used each type of equipment. Another attribute in this case may include a group activity attribute.

The statistical processing unit 143 may obtain an aggregate value or a ratio in time series according to, for example, the selection information, or may obtain the aggregate value or the ratio as an indicator collectively indicating the entire target time.

The output unit 144 outputs various types of information under the control of the output control unit 145 and the like. The output control unit 145 causes the output unit 144 to output the various types of information. For example, the output control unit 145 causes the output unit 144 to output the statistical processing result generated by the statistical processing unit 143.

The output includes display, transmission, and recording. That is, the output control unit 145 may cause the output unit 144 to perform display as a display unit. The output control unit 145 may cause the output unit 144 as a transmission unit to transmit data to a designated device. The output control unit 145 may cause the output unit 144 as a data write unit to record data onto a recording medium. The output method is not limited thereto.

The functional configuration example of the information processing system 100 according to the first example embodiment has been mainly described above. From here, a physical configuration example of the information processing system 100 according to the first example embodiment will be described.

### (Physical Configuration Example of Information Processing System 100 According to First Example Embodiment)

The information processing system 100 physically includes a video storage device 102, a video analysis device 103, and a statistical processing device 104, which are connected to each other via a network NT. Each of the video storage device 102, the video analysis device 103, and the statistical processing device 104 includes a single physically different device.

The functions of the imaging devices 101_1 to 101_M, the video storage device 102, the video analysis device 103, and the statistical processing device 104 are only required to be provided as the entire information processing system 100. That is, for example, some or all of the functions of the imaging devices 101_1 to 101_M, the video storage device 102, the video analysis device 103, and the statistical processing device 104 may physically include a single device. For example, the imaging devices 101_1 to 101_M, the video storage device 102, the video analysis device 103, and the statistical processing device 104 may include, for example, a plurality of different devices connected via an appropriate communication line such as the network N for each of one or a plurality of functions thereof.

Each of the video storage device 102, the video analysis device 103, and the statistical processing device 104 according to the present example embodiment may be physically configured similarly. Here, a physical configuration example will be described with reference to the drawings using the video analysis device 103 as an example.

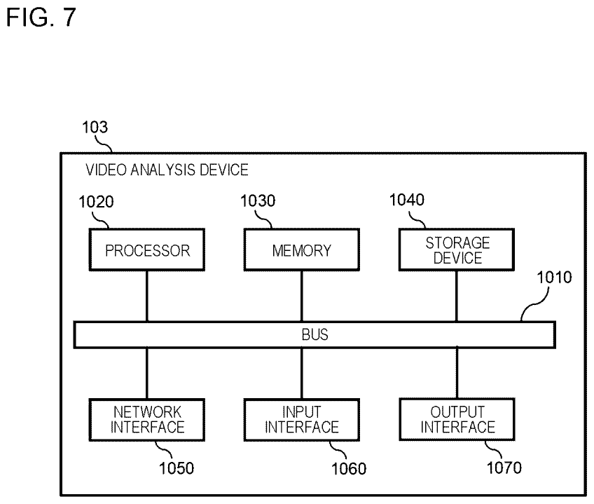

FIG. 7 is a diagram illustrating the physical configuration example of the video analysis device 103 according to the first example embodiment. The video analysis device 103 physically includes, for example, a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 mutually transmit and receive data. However, the method of connecting the processor 1020 and the like to each other is not limited to the bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a hard disk drive (HDD), a solid state drive (SSD), a memory card, a read only memory (ROM), or the like. The storage device 1040 stores a program module for implementing a function of a device (in the example of FIG. 7, the video analysis device 103) including the storage device 1040. The processor 1020 loads the program modules into the memory 1030 and executes the program modules, and thus the functions corresponding to the program modules are implemented.

The network interface 1050 is an interface that connects a device (in the example of FIG. 7, the video analysis device 103) including the network interface 1050 to the network NT.

The input interface 1060 is an interface for the user to input information. The input interface 1060 includes, for example, a touch panel, a keyboard, and a mouse.

The output interface 1070 is an interface for presenting information to the user. The output interface 1070 includes, for example, a liquid crystal panel and an organic electro-luminescence (EL) panel.

The physical configuration example of the information processing system 100 according to the first example embodiment has been described above. From here, an operation example of the information processing system 100 according to the first example embodiment will be described.

### (Operation Example of Information Processing System 100 According to First Example Embodiment)

The information processing system 100 executes information processing including, for example, video analysis processing and statistical processing. The video analysis processing and the customer statistical processing will be described with reference to the drawings.

### (Example of Video Analysis Processing According to First Example Embodiment)

The video analysis processing according to the present example embodiment is processing of processing a video relating to a facility to identify a plurality of attributes relating to each of a plurality of customers included in the video. The video analysis processing is started, for example, in a case where the video analysis device 103 receives the selection information, the selection time, and the like from the statistical processing device 104. A trigger for starting the video analysis processing is not limited to this, and the video analysis processing may be repeatedly executed, for example, in a case where the processing is performed in real time.

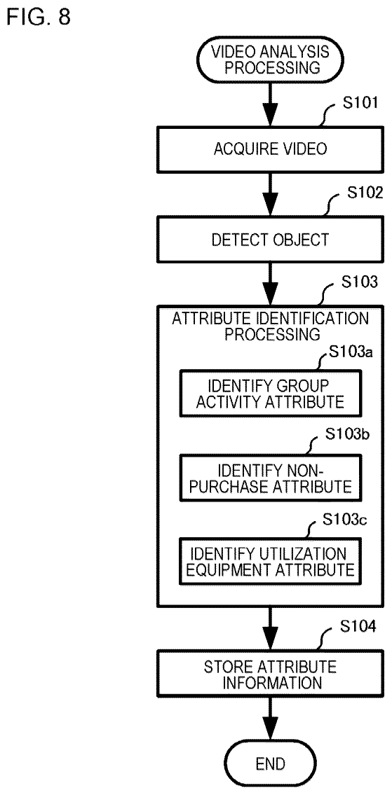

FIG. 8 is a flowchart illustrating an example of the video analysis processing according to the first example embodiment.

The video acquisition unit 131 acquires the video captured at the selection time included in the selection information received as the trigger or at a time corresponding to the selection time received as the trigger (step S101).

For example, the video acquisition unit 131 acquires the video captured at the time corresponding to the selection time from the video storage device 102.

The object detection unit 133 processes the video acquired in step S101 and detects an object included in the video (step S102).

For example, the object includes a customer and an item. In a case where the object detection unit 133 processes the video and detects the customer and the item included in the video, the object detection unit 133 generates attribute information including the customer identification information for the customer and the item identification information for the item.

The attribute identification unit 134 processes the video acquired in step S101 to identify a plurality of attributes relating to each of a plurality of customers included in the video (step S103).

For example, the group identification unit 134a processes a video relating to a facility to identify a group activity attribute relating to each of a plurality of customers included in the video (step S103a). For example, the non-purchase identification unit 134b processes a video relating to a facility to identify a non-purchase attribute relating to each of a plurality of customers included in the video (step S103b). For example, the utilization equipment identification unit 134c processes a video relating to a facility to identify a utilization equipment attribute relating to each of a plurality of customers included in the video (step S103c).

The attribute identification unit 134 generates attribute information in which a plurality of the identified attributes (in the present example embodiment, the individual/group activity attribute, the purchase/non-purchase attribute, and the utilization equipment attribute) are associated with each of a plurality of customers detected in step S102.

The attribute identification unit 134 stores the attribute information generated in step S103 in the attribute information storage unit 135 (step S104), and ends the video analysis processing.

The order of executing steps S103a to S103c may be changed as appropriate.

However, in a case where the identification result of another attribute is used to identify the attribute, the identification of the attribute may be executed after another attribute necessary to identify the attribute is identified.

### (Example of Customer Statistical Processing According to First Example Embodiment)

The customer statistical processing according to the present example embodiment is processing of performing statistical processing relating to a plurality of customers using at least one attribute included in a plurality of identified attributes. The customer statistical processing is started, for example, in a case where the selection reception unit 141 receives selection information corresponding to user's selection. The trigger for starting the customer statistical processing is not limited thereto.

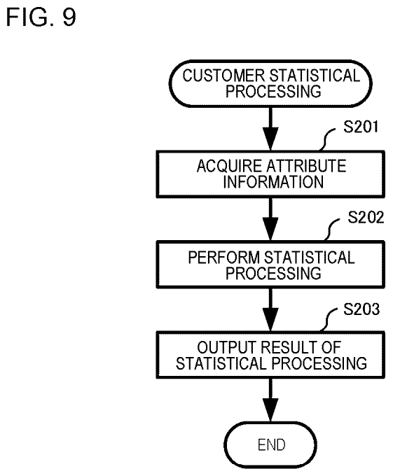

FIG. 9 is a flowchart illustrating an example of the customer statistical processing according to the first example embodiment.

The attribute information acquisition unit 142 acquires attribute information generated by executing the video analysis processing (step S201).

For example, the attribute information acquisition unit 142 requests the video captured at the target time included in the selection information received as the trigger from the video analysis device 103. In a case where this request is received, the attribute transmission unit 136 acquires the video captured at the target time included in the request from the attribute information storage unit 135 and transmits the acquired video. The attribute information acquisition unit 142 acquires the video transmitted from the attribute transmission unit 136.

The statistical processing unit 143 performs statistical processing by using the selection information received as the trigger for starting the customer statistical processing and the attribute information acquired in step S201 (step S202).

The output control unit 145 causes the output unit 144 to output the result of the statistical processing generated in step S202 (step S203), and ends the processing.

A plurality of customers who visit the facility are included in the video relating to the facility. Therefore, by executing the video analysis processing and the customer statistical processing, the statistical processing using the attributes can be performed for a plurality of customers who visit the facility.

### (Operation and Effect)

As described above, according to the present example embodiment, the information processing system 100 includes the attribute identification unit 134 and the statistical processing unit 143. The attribute identification unit 134 processes a video relating to a facility to identify a plurality of attributes relating to each of a plurality of customers. The statistical processing unit 143 uses at least one attribute included in the identified plurality of attributes to perform statistical processing relating to a plurality of customers. The at least one attribute includes a group activity attribute relating to customers who act in groups of a plurality of people.

Thus, a plurality of attributes relating to each of a plurality of customers who visit the facility can be identified, and statistical processing relating to a plurality of customers can be performed using at least one of the identified attributes. The at least one attribute includes a group activity attribute relating to customers who act in groups of a plurality of people. Therefore, it is possible to identify the activity of the customer in a facility according to whether a customer performs a group activity or a customer performs an individual activity.

According to the present example embodiment, the attribute further includes a non-purchase attribute relating to a customer who does not purchase a product in the facility.

Thus, the statistical processing relating to a plurality of customers can be performed using the non-purchase attribute. Therefore, it is possible to identify the activity of the customer in a facility according to whether a customer performs a group activity or a customer performs an individual activity further using the non-purchase attribute.

### (Second Example Embodiment)

A plurality of attributes are not limited to the individual/group activity attribute, the purchase/non-purchase attribute, and the utilization equipment attribute, which are described in the first example embodiment. In the second example embodiment, an example will be described in which the plurality of attributes include at least one of a group attribute, an age group, a distance attribute relating to an inter-customer distance, a store visit time attribute relating to a store visit time of a customer, a store visit means attribute relating to a store visit means of a customer, or a clothing attribute relating to clothing of a customer. An example of a method of identifying a group activity attribute and the type of group (family members, coworkers, sports teammates, friends, and the like) will also be described.

In the present example embodiment, in order to simplify the description, the description of the same configuration as that of the first example embodiment will be appropriately omitted.

The information processing system according to the present example embodiment includes a video analysis device 203 instead of the video analysis device 103 according to the first example embodiment. Except for this point, the information processing system according to the present example embodiment may be configured similarly to the information processing system 100 according to the first example embodiment.

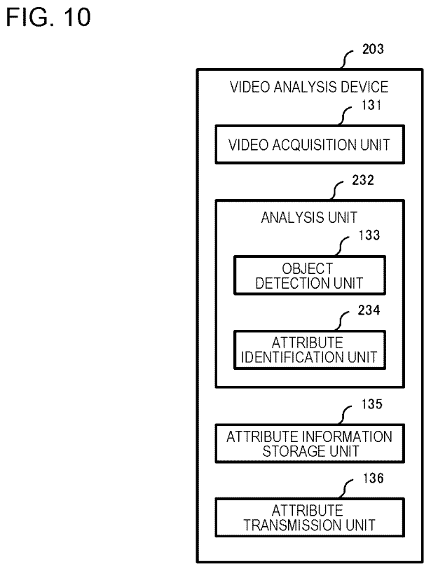

FIG. 10 is a diagram illustrating a functional configuration example of the video analysis device 203 according to a second example embodiment. The video analysis device 203 functionally includes, for example, an analysis unit 232 instead of the analysis unit 132 according to the first example embodiment. Except for this point, the video analysis device 203 may be configured similarly to the video analysis device 103 according to the first example embodiment.

In a case where the video acquisition unit 131 acquires a video, the analysis unit 232 processes the acquired video by using an analysis function similar to that of the analysis unit 132 according to the first example embodiment. The analysis unit 232 detects an object included in the video and identifies an attribute of the detected object.

The analysis unit 232 includes an object detection unit 133 similar to that of the first example embodiment and an attribute identification unit 234 instead of the attribute identification unit 134 according to the first example embodiment. Similarly to the attribute identification unit 134 according to the first example embodiment, the attribute identification unit 234 processes a video relating to a facility to identify a plurality of attributes relating to each of a plurality of customers included in the video. Similarly to the attribute identification unit 134 according to the first example embodiment, the attribute identification unit 234 generates attribute information including a plurality of attributes for each of a plurality of customers.

The plurality of attributes according to the present example embodiment include, for example, (1) an individual/group activity attribute. The plurality of attributes according to the present example embodiment further include at least one of (2) a purchase/non-purchase attribute, (3) a utilization equipment attribute, (4) an age group, (5) a distance attribute, (6) a store visit time attribute, (7) a store visit means attribute, or (8) a clothing attribute.

### (1) Example of Individual/Group Activity Attribute According to Second Example Embodiment

As in the first example embodiment, the individual/group activity attribute includes a group activity attribute, and the group identification information is used for the group activity attribute.

The individual/group activity attribute according to the present example embodiment further includes an attribute (group attribute) of a group to which a group customer belongs for the group customer.

The group attribute includes, for example, the type of group type (group type). The group attribute may be represented by a code predetermined in association with the group type. For example, the group type includes family members, coworkers, sports teammates, and friends, and codes “one”, “two”, “three”, and “four” may be predetermined by respectively associating the codes with the family members, the coworkers, the sports teammates, and the friends.

The group attribute is not limited thereto, and may be, for example, the number of people constituting a group, that is, the number of customers associated with the same group identification information, or the like. The group type is not limited thereto, and is only required to include at least one of family members, coworkers, sports teammates, or friends.

(2) The purchase/non-purchase attribute and (3) the utilization equipment attribute according to the present example embodiment may be similar to those of the first example embodiment.

### (4) Example of Age Group

A plurality of age groups may be predetermined, such as 12 years old or younger, 13 years old or older and 19 years old or younger, 20 years old or older and 29 years old or younger, 30 years old or older and 49 years old or younger, and 50 years old or older. The plurality of age groups may be represented by codes predetermined in association with each other. For example, the age groups include 12 years old or younger, 13 years old or older and 19 years old or younger, 20 years old or older and 29 years old or younger, 30 years old or older and 49 years old or younger, and 50 years old or older, and may be predetermined by respectively associating these age groups with codes “one”, “two”, “three”, “four”, and “five”. The age group is not limited thereto.

### (5) Example of Distance Attribute

The distance attribute is an attribute relating to an inter-customer distance which is a distance between a customer and another customer. The distance attribute may be represented by, for example, a distance between a customer and a person in a predetermined range or each of a plurality of customers.

### (6) Example of Store Visit Time Attribute

The store visit time attribute is an attribute relating to a time when the customer visits the store. The time when the customer visits the store is, for example, a time when the customer enters a facility through an entrance/exit, a time when the customer enters the site of the facility, or the like. The store visit time attribute may be represented by, for example, a time corresponding to the time when the customer visits the store.

The time when the customer visits the store is not limited to the time. A plurality of attributes may include an attribute (store exit time attribute) relating to a time when the customer exits the store together with the store visit time attribute or in addition to the store visit time attribute.

### (7) Example of Store Visit Means Attribute

The store visit means attribute is an attribute relating to a store visit means of a customer. For example, the store visit means is walking, bicycle, or automobile, and may be represented by using codes “one”, “two”, automobile identification information respectively associated with the walking, the bicycle, and the automobile. The automobile is an example of the store visit means that several people can use at the same time. The automobile identification information is identification information for identifying an automobile, and is an example of store visit means identification information.

### (8) Example of Clothing Attribute

The clothing attribute is an attribute relating to clothing. The clothing attribute includes, for example, a first clothing attribute relating to the type of clothing. The clothing attribute may further include at least one of a second clothing attribute relating to the color of the clothing, a third clothing attribute relating to the pattern of the clothing, or the like.

The first clothing attribute may be represented by a code predetermined in association with the type of clothing. For example, the type of clothing is a workwear, a uniform, or a suit, and codes “one”, “two”, and “three” may be respectively associated with the workwear, the uniform, and the suit and predetermined. The type of clothing is not limited thereto, and is only required to include at least one of the workwear, the uniform, the suit, or the like.

The first clothing attribute may include clothing type identification information for identifying clothing belonging to a predetermined type of clothing. The clothing type identification information may be used together with or instead of the code associated with the type of clothing as described above.

The predetermined type of clothing includes, for example, at least one of the workwear or the uniform. A worker who works in the same workplace often wears the same type of workwear. A player of the same team often wear the same type of uniform. By using the clothing type identification information, the types of workwear, uniform, and the like can be identified.

The second clothing attribute may be represented by, for example, at least one of a code predetermined in association with the color of clothing, a numerical value representing the color of clothing, or the like. The third clothing attribute may be represented by, for example, a code predetermined in association with the pattern of clothing (for example, a pattern design). The pattern design of the clothing includes plain, various types of checks, and stripes. The method of representing each of the second clothing attribute and the third clothing attribute is not limited thereto.

Also in the present example embodiment, the attribute identification unit 234 includes an identification unit for identifying each of a plurality of attributes.

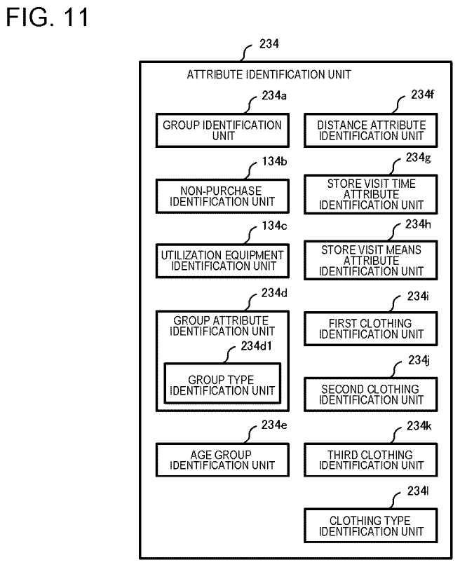

FIG. 11 is a diagram illustrating a functional configuration example of the attribute identification unit 234 according to the second example embodiment. The attribute identification unit 234 functionally includes, for example, a group identification unit 234a instead of the group identification unit 134a according to the first example embodiment, and a non-purchase identification unit 134b and a utilization equipment identification unit 134c similar to those of the first example embodiment.

The attribute identification unit 234 functionally further includes, for example, a group attribute identification unit 234d including a group type identification unit 234d1, an age group identification unit 234e, and a distance attribute identification unit 234f. The attribute identification unit 234 functionally further includes, for example, a store visit time attribute identification unit 234g, a store visit means attribute identification unit 234h, a first clothing identification unit 234i, a second clothing identification unit 234j, a third clothing identification unit 234k, and a clothing type identification unit 234l.

Similarly to the group identification unit 134a according to the first example embodiment, the group identification unit 234a processes a video relating to a facility to identify a group activity attribute relating to each of a plurality of customers included in the video. The group identification unit 234a associates, for example, an individual/group activity attribute with each of a plurality of customers included in the attribute information based on the identification result.

Specifically, the group identification unit 234a identifies the group activity attribute relating to each of a plurality of customers using a first attribute group of each of the plurality of customers and one or more first determination conditions.

The first attribute group includes at least one attribute selected in advance as an attribute used to determine the group customer from a plurality of attributes. The first attribute group includes, for example, at least one of an attribute age group, a distance attribute, a store visit time attribute, a store visit means attribute, a clothing attribute, or the like.

The first determination condition is a condition for determining a group customer. The first determination condition may be defined in advance using the first attribute group.

Each of the first determination conditions includes at least one of the following plurality of condition elements. The first determination condition and the condition element are not limited to the following examples. A method of identifying the group type using the condition element is not limited to the following example.

A condition element 1 (condition relating to an age group) is that the age groups are common to each other or different from each other within a predetermined range. For example, the group type of the group satisfying the condition element 1 can be identified as a friend. The condition element 1 may further include, for example, an element that the age group is equal to or less than a predetermined value.

A condition element 2 (condition relating to a distance at the store visit time) is that the inter-customer distance at the store visit time is within a predetermined first distance. A condition element 3 (condition 1 relating to the store visit time) is that a time difference between the times of entering the facility is within a predetermined second time. For example, a plurality of customers satisfying at least one of the condition element 2 or 3 can be identified as a group customer belonging to the same group.

A condition element 4 (condition 1 relating to family members) is that an inter-customer distance at the store visit time with a child whose age group is equal to or less than a predetermined age threshold is within a predetermined second distance. A condition element 5(condition 2 relating to family members) is that a time difference between the store visit times with the child is within a predetermined fourth time. A plurality of customers satisfying at least one of the condition element 4 or 5 are, for example, group customers belonging to the same group, and the group type of the group can be identified as a family member.

A condition element 6 (condition relating to the proximity activity in a facility) is that a proximity activity time is equal to or more than a fifth time that is a predetermined time length. The proximity activity time is a time length obtained by accumulating the time lengths in which the inter-customer distance is within a predetermined third distance over a period of staying in the facility. For example, a plurality of customers satisfying the condition element 6 can be identified as a group customer belonging to the same group.

A condition element 7 (condition 2 relating to the store visit time) is that a time difference between the times of entering the site of the facility using the automobile with different automobile identification information for identifying the automobile as the store visit means is within a predetermined third time. The site of the facility is, for example, a parking lot of the facility, a road in the site of the facility for entering the parking lot, or the like. For example, a plurality of customers satisfying the condition element 7 can be identified as a group customer belonging to the same group.

A condition element 8 (condition relating to the store visit means) is that, in a case where a plurality of people visit a store using an automobile which is a store visit means that can be used by the plurality of people at the same time, the plurality of people visit the store using an automobile with common automobile identification information. A plurality of customers satisfying the condition element 8 are, for example, customers who visit the store while riding in the same automobile, and thus can be identified as a group customer belonging to the same group.

A condition element 9 (condition 1 relating to clothing) is that the type of clothing is common. For example, a plurality of customers satisfying the condition element 9 can be identified as a group customer belonging to the same group. For example, in a case where the type of clothing of all the group customers belonging to the group is a suit, the group type of the group can be identified as a coworker.

A condition element 10 (condition 2 relating to clothing) is that the clothing type identification information is common. For example, a plurality of customers satisfying the condition element 10 can be identified as a group customer belonging to the same group. For example, a plurality of customers satisfying the condition element 10 can be identified as a coworker in a case where the clothing type identification information of the workwear is common, and can be identified as a sports teammate in a case where the clothing type identification information of the uniform is common.

The group identification unit 234a identifies the first attribute group of each of a plurality of customers using, for example, attribute information. The group identification unit 234a identifies the group activity attribute relating to the identified customer according to whether the first attribute group of the identified customer satisfies one or more first determination conditions.

For example, in a case where the first attribute group of the identified customer satisfies one or more first determination conditions, the group identification unit 234a sets a code “one” corresponding to the group customer to the individual/group activity attribute associated with the customer identified by the attribute information. In a case where the first attribute group of the identified customer does not satisfy one or more first determination conditions, the group identification unit 234a does not change the initial value of the individual/group activity attribute associated with the customer identified by the attribute information.

In this manner, the first determination condition is identified using an attribute other than the group activity attribute. Therefore, after each of the identification units 234e to 234l to be described later performs identification, the group identification unit 234a may identify the group activity attribute relating to each of a plurality of customers using the identification result. The method in which the group identification unit 234a identifies the group activity attribute is not limited to the example described here.

The group attribute identification unit 234d identifies the group attribute relating to the group customer. The group attribute identification unit 234d includes, for example, the group type identification unit 234d1.

The group type identification unit 234d1 identifies a group type associated with at least one first determination condition satisfied by the group customer using group type definition information. The group type identification unit 234d1 sets the identified group type as the group type of the group to which the group customer belongs.

The group type definition information is information that associates the group type with at least one first determination condition, and may be predetermined.

In a case where the example of the above-described first determination condition is used, the group type definition information associates, for example, the first determination condition including the condition element 1 with the group type: “friend”. For example, the group type definition information associates the first determination condition including at least one of the condition element 4 or 5 with the group type: “family member”. For example, the group type definition information associates the first determination condition including the condition element 9 and (a condition element 11) that the type of clothing is “suit” with the group type: “coworker”.

For example, the group type definition information associates the first determination condition including the condition element 10 and (a condition element 12) that the type of clothing is “workwear” with the group type: “coworker”. For example, the group type definition information associates the first determination condition including the condition element 10 and (a condition element 13) that the type of clothing is “uniform” with the group type: “sports teammate”.

In this manner, the group type is identified using an attribute other than the group activity attribute for the group customer. Therefore, after the group identification unit 234a and each of the identification units 234e to 234l to be described later performs identification, the group attribute identification unit 234d may identify the group attribute relating to the group customer using the identification unit. The group attribute identification unit 234d may associate, for example, the group activity attribute with each of a plurality of group customers included in the attribute information based on the identification result.

The group attribute identification unit 234d may include another identification unit for identifying the group attribute together with the group type identification unit 234d1 or instead of the group type identification unit 234d1. For example, the group attribute identification unit 234d may include a group size identification unit for identifying the number of customers constituting a group as the group attribute.

For example, the age group identification unit 234e processes a video relating to a facility to identify an age group relating to each of a plurality of customers included in the video. The age group identification unit 234e associates the age group with each of a plurality of customers included in the attribute information based on the identification result.

For example, the distance attribute identification unit 234f processes the video relating to the facility and obtains a distance between each of a plurality of customers included in the video and a person in a predetermined range or each of a plurality of customers. The distance may be represented by, for example, a distance in the image, but is not limited thereto. The distance attribute identification unit 234f associates the inter-customer distance with each of a plurality of customers included in the attribute information based on the obtained distance.

For example, the store visit time attribute identification unit 234g processes a video relating to a facility to identify a time when a plurality of customers included in the video visit the store. The store visit time attribute identification unit 234g associates the store visit time with each of a plurality of customers included in the attribute information based on the identification result.

For example, the store visit means attribute identification unit 234h processes a video relating to a facility to identify a store visit means of a plurality of customers included in the video. The store visit means may be identified, for example, by processing a video obtained by capturing an entrance/exit of a facility, a parking lot, or the like. The store visit means attribute identification unit 234h associates the store visit means with each of a plurality of customers included in the attribute information based on the identification result.

Each of the first to third clothing identification units 234i to 234k is an example of a clothing attribute identification unit that processes a video relating to a facility to identify the clothing attribute relating to each of a plurality of customers included in the video. The clothing attribute identification unit associates the clothing attribute with each of a plurality of customers included in the attribute information based on the identification result.

For example, the first clothing identification unit 234i processes the video relating to the facility to identify the type of clothing (first clothing attribute) of each of a plurality of customers included in the video. The first clothing identification unit 234i associates the first clothing attribute with each of a plurality of customers included in the attribute information based on the identification result.

For example, the second clothing identification unit 234j processes the video relating to the facility to identify the color of clothing (second clothing attribute) of each of a plurality of customers included in the video. The second clothing identification unit 234j associates the second clothing attribute with each of a plurality of customers included in the attribute information based on the identification result.

For example, the third clothing identification unit 234k processes the video relating to the facility to identify the pattern of clothing (third clothing attribute) of each of a plurality of customers included in the video. The third clothing identification unit 234k associates the third clothing attribute with each of a plurality of customers included in the attribute information based on the identification result.

For example, the clothing type identification unit 234l identifies the clothing type identification information using one or more of the first clothing attribute, the second clothing attribute, or the third clothing attribute, and the clothing type identification condition.

The clothing type identification condition is a condition for identifying clothing belonging to a predetermined type of clothing (for example, a workwear, a uniform, or the like). The clothing type identification condition is defined using, for example, a clothing similarity indicating the degree of similarity of clothing and a predetermined identification threshold. Specifically, for example, in a case where the clothing similarity has a larger value as the clothing is more similar, the clothing type identification condition indicates that the clothing similarity is equal to or more than the identification threshold.

The clothing similarity is obtained using, for example, the similarity of one or more of the second clothing attribute or the third clothing attribute. For example, the similarity relating to the second clothing attribute is the color similarity indicating a degree of similarity in the color of clothing. For example, the similarity relating to the third clothing attribute is the pattern similarity indicating a degree of similarity in the pattern of clothing. For example, the clothing type identification unit 234l obtains the clothing similarity by applying a predetermined weight to each of the color similarity based on the second clothing attribute and the pattern similarity based on the third clothing attribute and adding the color similarity and the pattern similarity. The method of obtaining the clothing similarity is not limited thereto.

The functional configuration example of the information processing system according to the second example embodiment has been mainly described above. The information processing system according to the second example embodiment may be physically configured similarly to the information processing system 100 according to the first example embodiment. For example, the video analysis device 203 may be physically configured similarly to the video analysis device 103 according to the first example embodiment. From here, an operation example of the information processing system according to the second example embodiment will be described.

### (Operation Example of Information Processing System According to Second Example Embodiment)

The information processing system according to the present example embodiment executes, for example, information processing including video analysis processing different from that of the first example embodiment and statistical processing similar to that of the first example embodiment. The video analysis processing according to the present example embodiment will be described with reference to the drawings.

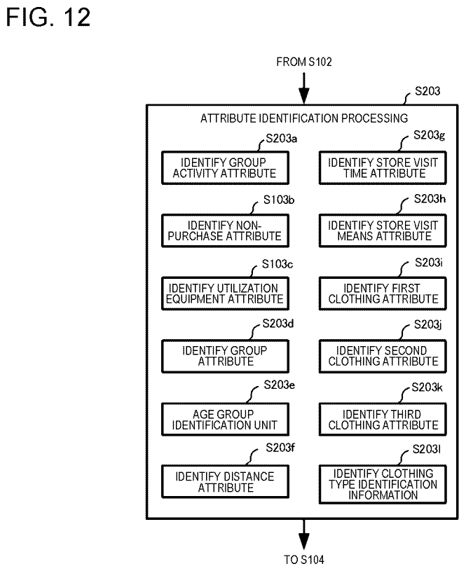

FIG. 12 is a flowchart illustrating an example of the video analysis processing according to the second example embodiment. The video analysis processing according to the present example embodiment includes attribute identification processing (step S203) instead of the attribute identification processing (step S103) according to the first example embodiment. Except for this, the video analysis processing according to the present example embodiment may be similar to the video analysis processing according to the first example embodiment.

As in the first example embodiment, in a case where steps S101 and S102 are executed, the attribute identification unit 234 processes the video acquired in step S101 to identify a plurality of attributes relating to each of a plurality of customers included in the video (step S203). Details of the attribute identification processing (step S203) are different from those of the attribute identification processing (step S103) according to the first example embodiment.

For example, as illustrated in FIG. 12, the group identification unit 234a processes a video relating to a facility to identify a group activity attribute relating to each of a plurality of customers included in the video using the first attribute group and one or more first determination conditions (step S203a).

For example, the non-purchase identification unit 134b and the utilization equipment identification unit 134c identify the non-purchase attribute and the utilization equipment attribute as in the first example embodiment (steps S103b and S103c).

For example, the group attribute identification unit 234d identifies the group attribute relating to each of a plurality of group customers identified in step S203a (step S203d). In step S203d, for example, the group type identification unit 234d1 identifies the group type, which is an example of the group attribute, for each of a plurality of group customers.

Here, the group activity attribute and the group attribute in steps S203a and S203d are identified using other attributes which are attributes other than the group activity attribute and the group attribute. Therefore, steps S203a and S203d may be executed using other attributes after the other attributes are identified by execution of other processing (steps S103b and S103c, and step S203e to S203l).

For example, the age group identification unit 234e processes a video relating to a facility to identify an age group relating to each of a plurality of customers included in the video (step S203e). For example, the distance attribute identification unit 234f identifies the distance attribute by processing the video relating to the facility and obtaining the inter-customer distance (step S203f). The inter-customer distance is a distance between each of a plurality of customers included in the video subjected to the processing and a person in a predetermined range or each of a plurality of other customers.

For example, the store visit time attribute identification unit 234g processes a video relating to a facility to identify a store visit time attribute relating to each of a plurality of customers included in the video (step S203g). For example, the store visit means attribute identification unit 234h processes a video relating to a facility to identify a store visit means attribute relating to each of a plurality of customers included in the video (step S203h).

For example, the first clothing identification unit 234i processes the video relating to the facility to identify the type of clothing (first clothing attribute) of each of a plurality of customers included in the video (step S203i). For example, the second clothing identification unit 234j processes the video relating to the facility to identify the color of clothing (second clothing attribute) of each of a plurality of customers included in the video (step S203j). For example, the third clothing identification unit 234k processes the video relating to the facility to identify the pattern of clothing (third clothing attribute) of each of a plurality of customers included in the video (step S203k).

For example, the clothing type identification unit 234l identifies the clothing type identification information using one or more of the first clothing attribute, the second clothing attribute, or the third clothing attribute, which are identified in steps S202i to S202k, and the clothing type identification condition (step S202l).

The clothing type identification information in step S203l is identified using the first to third clothing attributes. Therefore, after the first to third clothing attributes are identified by executing steps S203i to S203k, step S203l may be executed using the identified first to third clothing attributes.

The attribute identification unit 234 generates attribute information in which a plurality of attributes identified in steps S203a, S103b, S103c, and S203d to S203l are associated with each of a plurality of customers detected in step S102. As in the first example embodiment, the attribute identification unit 134 stores the attribute information generated in the attribute identification processing (step S203) in the attribute information storage unit 135 (step S104), and ends the video analysis processing.

The order of executing steps S203a, S103b, S103c, and S203d to S203l may be changed as appropriate. However, in a case where the identification result of another attribute is used to identify the attribute, the identification of the attribute may be executed after another attribute necessary to identify the attribute is identified.

By executing such video analysis processing, the group activity attribute and the group attribute can be identified. More attributes can be identified than those in the first example embodiment. Therefore, in the customer statistical processing, the statistical processing can be performed using more attributes than those in the first example embodiment.

### (Operation and Effect)

As described above, according to the present example embodiment, a plurality of attributes further include at least one of the age group of the customer, the distance attribute relating to an inter-customer distance, which is the distance between the customer and another customer, the store visit time attribute relating to the store visit time of the customer, the store visit means attribute relating to the store visit means of the customer, or the clothing attribute relating to the clothing of the customer. The attribute identification unit 234 includes the group identification unit 234a that identifies the group activity attribute relating to each of a plurality of customers by using the first attribute group including at least one of the age group, the distance attribute, the store visit time attribute, the store visit means attribute, or the clothing attribute, and one or more first determination conditions for determining customers who act in groups of a plurality of people.

Thus, the group activity attribute can be identified using the first attribute group. Therefore, it is possible to identify the activity of the customer in a facility according to whether a customer performs a group activity or a customer performs an individual activity.

According to the present example embodiment, a plurality of attributes include a group attribute relating to a group. The attribute identification unit 234 further includes the group attribute identification unit 234d that identifies the group attribute relating to the customers who act in groups of a plurality of people.

Thus, the group attribute relating to the customers who act in groups of a plurality of people can be identified. Therefore, it is possible to identify the activity of the customer in a facility according to whether a customer performs a group activity or a customer performs an individual activity further using the group attribute.

According to the present example embodiment, the group attribute includes the group type. The group attribute identification unit 234d includes the group type identification unit 234d1. The group type definition information associates the group type with at least one first determination condition. By using the group type definition information, the group type identification unit 234d1 identifies the group type associated with at least one first determination condition satisfied by customers who act in groups of a plurality of people as the group type of customers who act in groups of a plurality of people.

Thus, the group type of the customers who act in groups of a plurality of people can be identified. Therefore, it is possible to identify the activity of the customer in a facility according to whether a customer performs a group activity or a customer performs an individual activity further using the group type.

According to the present example embodiment, each of one or more first determination conditions includes at least one of the following first to sixth items.

The first item is that the age groups are common to each other or different from each other within a predetermined range. The second item is that the inter-customer distance at the store visit time is within a predetermined first distance. The third item is that a time difference between the times of entering the facility is within a predetermined second time.

The fourth item is that an inter-customer distance at the store visit time with a child whose age group is equal to or less than a predetermined age threshold is within a predetermined second distance. The fifth item is that a time difference between the times at the store visit time with a child is within a predetermined fourth time. The sixth item is that a proximity activity time obtained by adding up the time length in which the inter-customer distance is within a predetermined third distance over a period of staying in the facility is equal to or more than a fifth time that is a predetermined time length.

Thus, the group activity attribute can be identified using one or more first determination conditions and the first attribute group. Therefore, it is possible to identify the activity of the customer in a facility according to whether a customer performs a group activity or a customer performs an individual activity.

According to the present example embodiment, the store visit means attribute includes store visit means identification information regarding a store visit means that can be used by a plurality of people at the same time. Each of one or more first determination conditions includes at least one of the following seventh or eighth items.

The seventh item is that a time difference between the times of entering the site of the facility using a store visit means with different store visit means identification information for identifying the store visit means is within a predetermined third time. The eighth item is that, in a case where a plurality of people visit a store using a store visit means that can be used by the plurality of people at the same time, the plurality of people visit the store using the store visit means with common store visit means identification information.

Thus, the group activity attribute can be identified using the store visit means. Therefore, it is possible to identify the activity of the customer in a facility according to whether a customer performs a group activity or a customer performs an individual activity.

According to the present example embodiment, the clothing attribute includes a first clothing attribute relating to the type of clothing. The first clothing attribute includes clothing type identification information for identifying clothing belonging to a predetermined type of clothing. Each of one or more first determination conditions includes at least one of the following ninth or tenth items.

The ninth item is that the type of clothing is common. The tenth item is that the clothing type identification information is common.

Thus, at least the group activity attribute can be identified using the clothing attribute. Therefore, it is possible to identify the activity of the customer in a facility according to whether a customer performs a group activity or a customer performs an individual activity.

According to the present example embodiment, the clothing attribute further includes one or more of a second clothing attribute relating to the color of clothing or a third clothing attribute relating to the pattern of clothing. The attribute identification unit 234 includes one or more of the first clothing identification unit 234i, the second clothing identification unit 234j, or the third clothing identification unit 234k, and the clothing type identification unit 234l.

The first clothing identification unit 234i identifies the type of clothing of each of a plurality of customers. The second clothing identification unit 234j identifies the color of clothing of each of a plurality of customers. The third clothing identification unit 234k identifies the pattern of clothing of each of a plurality of customers.

The clothing type identification unit 234l identifies the clothing type identification information using one or more of the first clothing attribute, the second clothing attribute, or the third clothing attribute, and the clothing type identification condition. The clothing type identification condition is a condition for identifying clothing belonging to a predetermined type of clothing.

Thus, at least the group activity attribute can be identified using the clothing attribute. Therefore, it is possible to identify the activity of the customer in a facility according to whether a customer performs a group activity or a customer performs an individual activity.

The group type can be identified using the clothing type identification information. Therefore, it is possible to identify the activity of the customer in a facility according to whether a customer performs a group activity or a customer performs an individual activity further using the group type.

According to the present example embodiment, the clothing type identification condition is defined using a clothing similarity indicating the degree of similarity of clothing and a predetermined identification threshold. The clothing similarity is obtained using the similarity of one or more of the second clothing attribute or the third clothing attribute.

Thus, the clothing type identification information can be identified using the clothing similarity corresponding to the similarity of one or more of the second clothing attribute or the third clothing attribute. At least the group activity attribute can be identified using the clothing attribute including the clothing type identification information. Therefore, it is possible to identify the activity of the customer in a facility according to whether a customer performs a group activity or a customer performs an individual activity.

The group type can be identified using the clothing type identification information.

Therefore, it is possible to identify the activity of the customer in a facility according to whether a customer performs a group activity or a customer performs an individual activity further using the group type.

### (Third Example Embodiment)

In the present example embodiment, an example of a method of identifying the non-purchase attribute described in the first example embodiment will be described.

In the present example embodiment, in order to simplify the description, the description of the same configuration as that of the first example embodiment will be appropriately omitted.

The information processing system according to the present example embodiment includes a video analysis device 303 instead of the video analysis device 103 according to the first example embodiment. Except for this point, the information processing system according to the present example embodiment may be configured similarly to the information processing system 100 according to the first example embodiment.

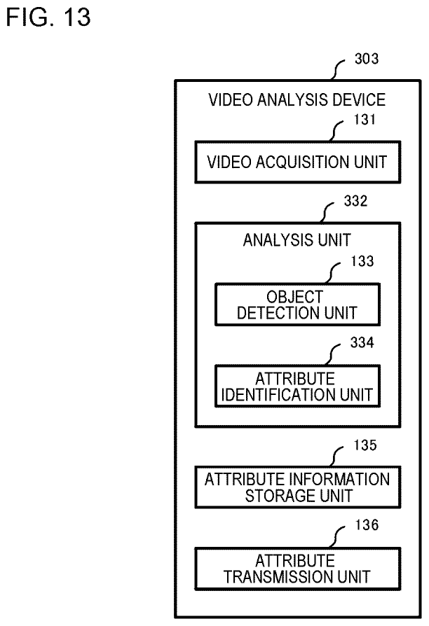

FIG. 13 is a diagram illustrating a functional configuration example of the video analysis device 303 according to a third example embodiment. The video analysis device 203 functionally includes, for example, an analysis unit 332 instead of the analysis unit 132 according to the first example embodiment. Except for this point, the video analysis device 303 may be configured similarly to the video analysis device 103 according to the first example embodiment.

In a case where the video acquisition unit 131 acquires a video, the analysis unit 332 processes the acquired video by using an analysis function similar to that of the analysis unit 132 according to the first example embodiment. The analysis unit 332 detects an object included in the video and identifies an attribute of the detected object.

The analysis unit 332 includes an object detection unit 133 similar to that of the first example embodiment and an attribute identification unit 334 instead of the attribute identification unit 134 according to the first example embodiment. Similarly to the attribute identification unit 134 according to the first example embodiment, the attribute identification unit 334 processes a video relating to a facility to identify a plurality of attributes relating to each of a plurality of customers included in the video, and generates attribute information including a plurality of attributes relating to each of a plurality of customers.

The plurality of attributes according to the present example embodiment include, for example, (1) an individual/group activity attribute. The plurality of attributes according to the present example embodiment further include at least one of (2) a purchase/non-purchase attribute, (3) a utilization equipment attribute, (9) a payment/non-payment attribute, or (10) a baggage attribute. (1) the individual/group activity attribute, (2) the purchase/non-purchase attribute and (3) the utilization equipment attribute according to the present example embodiment may be similar to those of the first example embodiment.

### (9) Example of Payment/Non-Payment Attribute

The payment/non-payment attribute is an attribute relating to whether the customer is a payment customer or a non-payment customer. The payment customer is a customer who has made a payment for a product in a facility. The non-payment customer is a customer who did not made a payment for a product in a facility.

The payment/non-payment attribute includes at least one of a payment attribute or a non-payment attribute. The payment attribute is an attribute indicating a payment customer. The non-payment attribute is an attribute indicating a non-payment customer.

In the present example embodiment, the payment/non-payment attribute is represented by two codes “zero” and “one” respectively predetermined in association with the payment customer and the non-payment customer. In this case, “zero” for the payment/non-payment attribute is an example of the payment attribute. In this case, “one” for the payment/non-payment attribute is an example of the non-payment attribute.

### (10) Example of Baggage Attribute

The baggage attribute is an attribute relating to baggage carried by a customer. The baggage attribute includes, for example, at least one of a first baggage attribute relating to the color of baggage, a second baggage attribute relating to the pattern of baggage, or a third baggage attribute relating to the shape of baggage.

The first baggage attribute may be represented by, for example, at least one of a code predetermined in association with the color of baggage, a numerical value representing the color of baggage, or the like.

The second baggage attribute may be represented by, for example, a code predetermined in association with the pattern of clothing (a pattern design). The pattern design of the baggage is a pattern of a shopping bag or a pattern of a product such as a product packaging pattern or a package pattern, which is being sold in a facility. The shopping bag includes a bag provided in the facility (for example, a plastic bag), and a bag owned by the customer to put the purchased product.

The third baggage attribute may be represented by, for example, a code predetermined in association with the shape of clothing (a shape pattern). The shape pattern of the baggage is the shape of a shopping bag or the shape of a product being sold in a facility.

The details of the baggage attribute are not limited to the color, pattern, and shape of the baggage, and may include, for example, a size.

Also in the present example embodiment, the attribute identification unit 334 includes an identification unit for identifying each of a plurality of attributes.

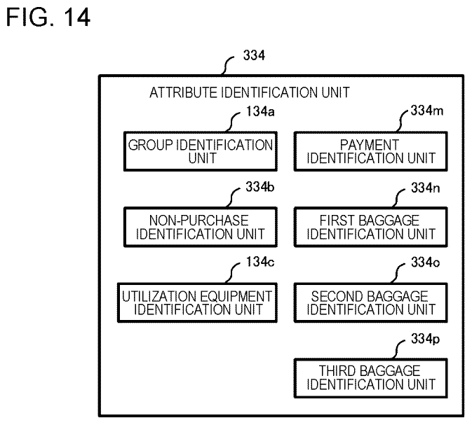

FIG. 14 is a diagram illustrating a functional configuration example of the attribute identification unit 334 according to the third example embodiment. The attribute identification unit 334 functionally includes, for example, a group identification unit 134a and a utilization equipment identification unit 134c according to the first example embodiment, and a non-purchase identification unit 334b instead of the non-purchase identification unit 134b according to the first example embodiment.

The attribute identification unit 334 functionally includes, for example, a payment identification unit 334m, a first baggage identification unit 334n, a second baggage identification unit 334o, and a third baggage identification unit 334p.

Similarly to the group identification unit 134a according to the first example embodiment, the non-purchase identification unit 334b processes a video relating to a facility to identify a non-purchase attribute relating to each of a plurality of customers included in the video. The non-purchase identification unit 334b associates, for example, a purchase/non-purchase attribute with each of a plurality of customers included in the attribute information based on the identification result.

Specifically, the non-purchase identification unit 334b identifies the non-purchase attribute relating to each of a plurality of customers using a second attribute group of each of the plurality of customers and one or more second determination conditions.

The second attribute group includes at least one attribute selected in advance as an attribute used to determine the non-purchasing customer from a plurality of attributes. The second attribute group includes, for example, at least one of a payment attribute, a baggage attribute, or the like.

The second determination condition is a condition for determining a non-purchasing customer. The second determination condition may be defined in advance using the second attribute group.

One or more second determination conditions include, for example, at least one of the following second determination conditions 1 and 2.

A second determination condition 1 is that a payment device of the facility is not used.

A second determination condition 2 is that the baggage attribute relating to a customer exiting a facility is not a purchased baggage predetermined using one or more of the first baggage attribute, the second baggage attribute, or the third baggage attribute. The purchased baggage is baggage purchased by a customer in a facility. For example, the purchased baggage is baggage held by a customer when the customer exits the facility and is, for example, a predetermined shopping bag, a product being sold in the facility, or the like.

The second determination condition is not limited to the example described above.

The non-purchase identification unit 334b identifies the second attribute group of each of a plurality of customers using, for example, attribute information. The non-purchase identification unit 334b identifies the non-purchase attribute relating to the identified customer according to whether the second attribute group of the identified customer satisfies the second determination condition.

For example, in a case where the second attribute group of the identified customer does not satisfy one or more second determination conditions, the non-purchase identification unit 334b sets a code “zero” corresponding to the purchasing customer to the purchase/non-purchase attribute associated with the customer identified by the attribute information. In a case where the first attribute group of the identified customer satisfies one or more first determination conditions, the non-purchase identification unit 334b does not change the initial value “one” of the purchase/non-purchase attribute associated with the customer identified by the attribute information.

In this manner, the second determination condition is identified using an attribute other than the non-purchase attribute. Therefore, after each of the identification units 334m to 334p to be described later performs identification, the non-purchase identification unit 334b may identify the non-purchase attribute relating to each of a plurality of customers using the identification result. The method in which the non-purchase identification unit 334b identifies the non-purchase attribute is not limited to the example described here.

For example, the payment identification unit 334m processes a video relating to a facility to identify the payment attribute relating to each of a plurality of customers included in the video using a third determination condition for determining whether the customer uses the payment device. The third determination condition is, for example, a condition that a time length during which each of a plurality of customers stays within a predetermined range from the payment device in the facility is equal to or more than a first time that is a predetermined time length. The third determination condition is not limited thereto.

The payment identification unit 334m associates the payment attribute with each of a plurality of customers included in the attribute information based on the identification result.

Each of the first to third baggage attribute identification units 334n to 334p is an example of a baggage attribute identification unit that processes a video relating to a facility to identify the baggage attribute relating to each of a plurality of customers included in the video. The baggage attribute identification unit associates the baggage attribute with each of a plurality of customers included in the attribute information based on the identification result.

For example, the first baggage identification unit 334n processes a video relating to a facility to identify an attribute (first baggage attribute) relating to the color of baggage owned by each of a plurality of customers included in the video. The first baggage identification unit 334n associates the first baggage attribute with each of a plurality of customers included in the attribute information based on the identification result.

For example, the second baggage identification unit 3340 processes a video relating to a facility to identify an attribute (second baggage attribute) relating to the pattern of baggage owned by each of a plurality of customers included in the video. The second baggage identification unit 334o associates the second baggage attribute with each of a plurality of customers included in the attribute information based on the identification result.

For example, the third baggage identification unit 334p processes a video relating to a facility to identify an attribute (third baggage attribute) relating to the shape of baggage owned by each of a plurality of customers included in the video. The third baggage identification unit 334p associates the third baggage attribute with each of a plurality of customers included in the attribute information based on the identification result.

The functional configuration example of the information processing system according to the third example embodiment has been mainly described above. The information processing system according to the third example embodiment may be physically configured similarly to the information processing system 100 according to the first example embodiment. For example, the video analysis device 303 may be physically configured similarly to the video analysis device 103 according to the first example embodiment. From here, an operation example of the information processing system according to the third example embodiment will be described.

### (Operation Example of Information Processing System According to Third Example Embodiment)

The information processing system according to the present example embodiment executes, for example, information processing including video analysis processing different from that of the first example embodiment and statistical processing similar to that of the first example embodiment. The video analysis processing according to the present example embodiment will be described with reference to the drawings.

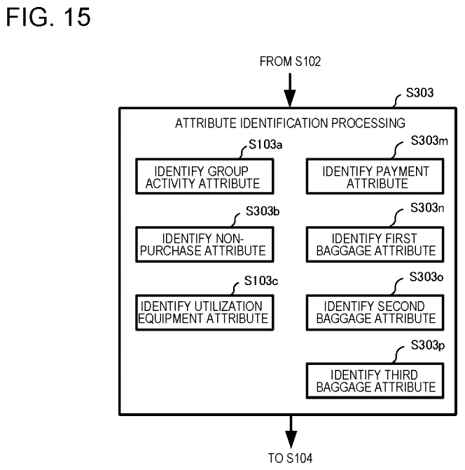

FIG. 15 is a flowchart illustrating an example of the video analysis processing according to the third example embodiment. The video analysis processing according to the present example embodiment includes attribute identification processing (step S303) instead of the attribute identification processing (step S103) according to the first example embodiment. Except for this, the video analysis processing according to the present example embodiment may be similar to the video analysis processing according to the first example embodiment.

As in the first example embodiment, in a case where steps S101 and S102 are executed, the attribute identification unit 334 processes the video acquired in step S101 to identify a plurality of attributes relating to each of a plurality of customers included in the video (step S303). Details of the attribute identification processing (step S303) are different from those of the attribute identification processing (step S103) according to the first example embodiment.

As illustrated in FIG. 15, for example, the group identification unit 134a identifies the group activity attribute as in the first example embodiment and the like (step S103a).

For example, the non-purchase identification unit 334b processes a video relating to a facility to identify the non-purchase attribute relating to each of a plurality of customers included in the video using the second attribute group for each of a plurality of customers and one or more second determination conditions (step S303b).

For example, the utilization equipment identification unit 134c identify the utilization equipment attribute as in the first example embodiment (step S103c).

For example, the payment identification unit 334m processes a video relating to a facility to identify the payment attribute relating to each of a plurality of customers included in the video using a predetermined third determination condition (step S303m).

Here, in step S303m, the payment attribute is identified using the first to third baggage attributes. Therefore, after the first to third baggage attributes are identified by executing steps S303n to S303p, step S303m may be executed using the identified first to third baggage attributes.

For example, the first baggage identification unit 334n processes a video relating to a facility to identify a first baggage attribute relating to each of a plurality of customers included in the video (step S303n). The second baggage identification unit 3340 processes a video relating to a facility to identify a second baggage attribute relating to each of a plurality of customers included in the video (step S303o). The third baggage identification unit 334p processes a video relating to a facility to identify a third baggage attribute relating to each of a plurality of customers included in the video (step S303p).

The attribute identification unit 334 generates attribute information in which a plurality of attributes identified in steps S103a, S303b, S103c, and S203m to S203p are associated with each of a plurality of customers detected in step S102. As in the first example embodiment, the attribute identification unit 334 stores the attribute information generated in the attribute identification processing (step S303) in the attribute information storage unit 135 (step S104), and ends the video analysis processing.

The order of executing steps S103a, S303b, S103c, and S203m to S203p may be changed as appropriate. However, in a case where the identification result of another attribute is used to identify the attribute, the identification of the attribute may be executed after another attribute necessary to identify the attribute is identified.

By executing such video analysis processing, the non-purchase attribute can be identified. More attributes can be identified than those in the first example embodiment. Therefore, in the customer statistical processing, the statistical processing can be performed using more attributes than those in the first example embodiment.

### (Operation and Effect)

As described above, according to the present example embodiment, a plurality of attributes further include at least one of the payment attribute indicating that the payment for the product is performed in the facility or the baggage attribute relating to baggage owned by the customer.

The attribute identification unit 334 includes the non-purchase identification unit 334b that identifies the non-purchase attribute relating to the customer who does not purchase a product in the facility among a plurality of customers by using the second attribute group and one or more second determination conditions for determining the customer who does not purchase a product in the facility. The second attribute group includes, for example, at least one of the payment attribute, the baggage attribute, or the like.

Thus, the non-purchase attribute can be identified using the second attribute group. Therefore, it is possible to identify the activity of the customer in a facility according to whether a customer performs a group activity or a customer performs an individual activity further using the non-purchase attribute.

According to the present example embodiment, the baggage attribute includes one or more of the first baggage attribute, the second baggage attribute, or the third baggage attribute relating to each of the color, pattern, size, and shape of the baggage. The second determination condition includes at least one of the fact that the payment device in the facility is not used or the fact that the baggage attribute relating to the customer exiting the facility is not the purchased baggage. The purchased baggage is baggage predetermined using one or more of the first baggage attribute, the second baggage attribute, or the third baggage attribute.

Thus, the non-purchase attribute can be identified using the baggage attribute. Therefore, it is possible to identify the activity of the customer in a facility according to whether a customer performs a group activity or a customer performs an individual activity further using the non-purchase attribute.

According to the present example embodiment, the attribute identification unit 334 further includes the payment identification unit 334m that identifies the payment attribute using the third determination condition for determining whether the customer uses the payment device.

Thus, the payment attribute can be identified, and the non-purchase attribute can be identified using the identified payment attribute. Therefore, it is possible to identify the activity of the customer in a facility according to whether a customer performs a group activity or a customer performs an individual activity further using the non-purchase attribute.

Although the example embodiments of the present invention have been described above with reference to the drawings, these are examples of the present invention, and various configurations other than the above can be used.

In the plurality of flowcharts used in the above description, a plurality of steps (processing) is described in order, but the execution order of the steps executed in each example embodiment is not limited to the described order. In each example embodiment, the order of the illustrated steps can be changed as long as there is no problem in terms of content. The above-described example embodiments can be combined within a range in which the contents are not contradictory.

Some or all of the above example embodiments may be described as the following supplementary notes, but are not limited to the following.
1. An information processing system including:
   an attribute identification means for processing a video relating to a facility to identify a plurality of attributes relating to each of a plurality of customers; and
   a statistical processing means for performing statistical processing relating to the plurality of customers by using at least one attribute included in the identified plurality of attributes,
   in which the at least one attribute includes a group activity attribute relating to customers who act in groups of a plurality of people.
2. The information processing system according to 1.,
   in which the attribute further includes a non-purchase attribute relating to a customer who does not purchase a product in the facility.
3. The information processing system according to 1. or 2.,
   in which the plurality of attributes further include at least one of an age group of the customer, a distance attribute relating to an inter-customer distance which is a distance between the customer and another customer, a store visit time attribute relating to a store visit time of the customer, a store visit means attribute relating to a store visit means of the customer, or a clothing attribute relating to clothing of the customer, and
   the attribute identification means includes a group identification means for identifying the group activity attribute relating to each of the plurality of customers by using a first attribute group including at least one of the age group, the distance attribute, the store visit time attribute, the store visit means attribute, or the clothing attribute, and one or more first determination conditions for determining customers who act in the groups of a plurality of people.
4. The information processing system according to 3.,
   in which the plurality of attributes include a group attribute relating to the group, and
   the attribute identification means further includes a group attribute identification means for identifying the group attribute relating to customers who act in the groups of a plurality of people.
5. The information processing system according to 4.,
   in which the group attribute includes the group type, and
   the group attribute identification means includes a group type identification means for identifying the group type associated with the at least one first determination condition satisfied by the customers who act in the groups of a plurality of people as the group type of the customers who act in the groups of a plurality of people by using group type definition information that associates the group type with the at least one first determination condition.
6. The information processing system according to any one of 3. to 5.,
   in which each of the one or more first determination conditions includes at least one of:
   a fact that the age groups are common to each other or differ within a predetermined range;
   a fact that the inter-customer distance at a store visit time is within a predetermined first distance;
   a time difference between times of entering the facility is within a predetermined second time;
   a fact that the inter-customer distance at the store visit time with a child whose age group is equal to or less than a predetermined age threshold is within a predetermined second distance;
   a fact that a time difference between the store visit times with the child is within a predetermined fourth time; or
   a fact that a proximity activity time obtained by adding up a time length in which the inter-customer distance is within a predetermined third distance over a period of staying in the facility is equal to or more than a fifth time which is a predetermined time length.
7. The information processing system according to any one of 3. to 6.,
   in which the store visit means attribute includes the store visit means identification information regarding the store visit means that is capable of being used by a plurality of people at the same time, and
   each of the one or more first determination conditions includes at least one of
   a fact that a time difference between times of entering a site of the facility by using the store visit means with different store visit means identification information for identifying the store visit means is within a predetermined third time, or
   a fact that in a case where the plurality of people visit a store using the store visit means that is capable of being used by the plurality of people at the same time, the plurality of people visit the store using the store visit means with common store visit means identification information.
8. The information processing system according to any one of 3. to 7.,
   in which the clothing attribute includes a first clothing attribute relating to a type of the clothing,
   the first clothing attribute includes clothing type identification information for identifying clothing belonging to a predetermined type of clothing, and
   each of the one or more first determination conditions includes at least one of
   a fact that the type of the clothing is common, or
   a fact that the clothing type identification information is common.
   9. The information processing system according to 8.,
   in which the clothing attribute further includes one or more of a second clothing attribute relating to a color of the clothing or a third clothing attribute relating to a pattern of the clothing, and
   the attribute identification means includes
   one or more of a first clothing identification means for identifying the type of the clothing of each of the plurality of customers,
   a second clothing identification means for identifying a color of the clothing of each of the plurality of customers, or
   a third clothing identification means for identifying a pattern of the clothing of each of the plurality of customers, and
   a clothing type identification means for identifying the clothing type identification information by using one or more of the first clothing attribute, the second clothing attribute, or the third clothing attribute and a clothing type identification condition for identifying clothing belonging to a predetermined type of clothing.
10. The information processing system according to 9.,
   in which the clothing type identification condition is defined using clothing similarity indicating a degree of similarity of the clothing and a predetermined identification threshold, and
   the clothing similarity is obtained using the similarity of one or more of the second clothing attribute or the third clothing attribute.
11. The information processing system according to any one of 2. to 10.,
   in which the plurality of attributes further include at least one of a payment attribute indicating that payment for a product is performed in the facility and a baggage attribute relating to baggage carried by the customer, and
   the attribute identification means includes a non-purchase identification means for identifying the non-purchase attribute relating to a customer, who does not purchase a product in the facility, among the plurality of customers by using a second attribute group including at least one of the payment attribute or the baggage attribute and one or more second determination conditions for determining the customer who does not purchase a product in the facility.
12. The information processing system according to 11.,
   in which the baggage attribute includes one or more of a first baggage attribute, a second baggage attribute, or a third baggage attribute relating to each of a color, a pattern, a size, and a shape of the baggage, and
   the second determination condition includes at least one of
   a fact that a payment device in the facility is not used, or
   a fact that the baggage attribute relating to the customer who exits the facility is not a purchased baggage predetermined using one or more of the first baggage attribute, the second baggage attribute, or the third baggage attribute.
13. The information processing system according to 12.,
   in which the attribute identification means further includes a payment identification means for identifying the payment attribute using a third determination condition for determining whether the customer uses the payment device.
14. The information processing system according to any one of 1. to 13.,
   in which the plurality of attributes further include a utilization equipment attribute relating to equipment of the facility used by the customer.
15. An information processing method including causing one or more computers to:
   process a video relating to a facility to identify a plurality of attributes relating to each of a plurality of customers; and
   perform statistical processing relating to the plurality of customers by using at least one attribute included in the identified plurality of attributes,
   in which the at least one attribute includes a group activity attribute relating to customers who act in groups of a plurality of people.
16. The information processing method according to 15.,
   in which the attribute further includes a non-purchase attribute relating to a customer who does not purchase a product in the facility.
17. The information processing method according to 15. or 16.,
   in which the plurality of attributes further include at least one of an age group of the customer, a distance attribute relating to an inter-customer distance which is a distance between the customer and another customer, a store visit time attribute relating to a store visit time of the customer, a store visit means attribute relating to a store visit means of the customer, or a clothing attribute relating to clothing of the customer, and
   the identifying of the plurality of attributes includes identifying the group activity attribute relating to each of the plurality of customers by using a first attribute group including at least one of the age group, the distance attribute, the store visit time attribute, the store visit means attribute, or the clothing attribute, and one or more first determination conditions for determining customers who act in the groups of a plurality of people.
18. The information processing method according to 17.,
   in which the plurality of attributes include a group attribute relating to the group, and
   the identifying of the plurality of attributes further includes identifying the group attribute relating to customers who act in the groups of a plurality of people.
19. The information processing method according to 18.,
   in which the group attribute includes the group type, and
   the identifying of the group attribute includes identifying the group type associated with the at least one first determination condition satisfied by the customers who act in the groups of a plurality of people as the group type of the customers who act in the groups of a plurality of people by using group type definition information that associates the group type with the at least one first determination condition.
20. The information processing method according to any one of 17. to 19.,
   in which each of the one or more first determination conditions includes at least one of:
   a fact that the age groups are common to each other or differ within a predetermined range;
   a fact that the inter-customer distance at a store visit time is within a predetermined first distance;
   a time difference between times of entering the facility is within a predetermined second time;
   a fact that the inter-customer distance at the store visit time with a child whose age group is equal to or less than a predetermined age threshold is within a predetermined second distance;
   a fact that a time difference between the store visit times with the child is within a predetermined fourth time; or
   a fact that a proximity activity time obtained by adding up a time length in which the inter-customer distance is within a predetermined third distance over a period of staying in the facility is equal to or more than a fifth time which is a predetermined time length.
21. The information processing method according to any one of 17. to 20.,
   in which the store visit means attribute includes the store visit means identification information regarding the store visit means that is capable of being used by a plurality of people at the same time, and
   each of the one or more first determination conditions includes at least one of
   a fact that a time difference between times of entering a site of the facility by using the store visit means with different store visit means identification information for identifying the store visit means is within a predetermined third time, or
   a fact that in a case where the plurality of people visit a store using the store visit means that is capable of being used by the plurality of people at the same time, the plurality of people visit the store using the store visit means with common store visit means identification information.
22. The information processing method according to any one of 17. to 21.,
   in which the clothing attribute includes a first clothing attribute relating to a type of the clothing,
   the first clothing attribute includes clothing type identification information for identifying clothing belonging to a predetermined type of clothing, and
   each of the one or more first determination conditions includes at least one of
   a fact that the type of the clothing is common, or
   a fact that the clothing type identification information is common.
23. The information processing method according to 22.,
   in which the clothing attribute further includes one or more of a second clothing attribute relating to a color of the clothing or a third clothing attribute relating to a pattern of the clothing, and
   the identifying of the plurality of attributes includes
   one or more of identifying the type of the clothing of each of the plurality of customers,
   identifying a color of the clothing of each of the plurality of customers, or
   identifying a pattern of the clothing of each of the plurality of customers, and
   identifying the clothing type identification information by using one or more of the first clothing attribute, the second clothing attribute, or the third clothing attribute and a clothing type identification condition for identifying clothing belonging to a predetermined type of clothing.
24. The information processing method according to 23.,
   in which the clothing type identification condition is defined using clothing similarity indicating a degree of similarity of the clothing and a predetermined identification threshold, and
   the clothing similarity is obtained using the similarity of one or more of the second clothing attribute or the third clothing attribute.
25. The information processing method according to any one of 16. to 24.,
   in which the plurality of attributes further include at least one of a payment attribute indicating that payment for a product is performed in the facility and a baggage attribute relating to baggage carried by the customer, and
   the identifying of the plurality of attributes includes identifying the non-purchase attribute relating to a customer, who does not purchase a product in the facility, among the plurality of customers by using a second attribute group including at least one of the payment attribute or the baggage attribute and one or more second determination conditions for determining the customer who does not purchase a product in the facility.
26. The information processing method according to 25.,
   in which the baggage attribute includes one or more of a first baggage attribute, a second baggage attribute, or a third baggage attribute relating to each of a color, a pattern, a size, and a shape of the baggage, and
   the second determination condition includes at least one of
   a fact that a payment device in the facility is not used, or
   a fact that the baggage attribute relating to the customer who exits the facility is not a purchased baggage predetermined using one or more of the first baggage attribute, the second baggage attribute, or the third baggage attribute.
27. The information processing method according to 26.,
   in which the identifying of the plurality of attributes further includes identifying the payment attribute using a third determination condition for determining whether the customer uses the payment device.
28. The information processing method according to any one of 15. to 27.,
   in which the plurality of attributes further include a utilization equipment attribute relating to equipment of the facility used by the customer.
29. A program for causing one or more computers to execute processing of:
   processing a video relating to a facility to identify a plurality of attributes relating to each of a plurality of customers; and
   performing statistical processing relating to the plurality of customers by using at least one attribute included in the identified plurality of attributes,
   in which the at least one attribute includes a group activity attribute relating to customers who act in groups of a plurality of people.
30. The program according to 29.,
   in which the attribute further includes a non-purchase attribute relating to a customer who does not purchase a product in the facility.
31. The program according to 29. or 30.,
   in which the plurality of attributes further include at least one of an age group of the customer, a distance attribute relating to an inter-customer distance which is a distance between the customer and another customer, a store visit time attribute relating to a store visit time of the customer, a store visit means attribute relating to a store visit means of the customer, or a clothing attribute relating to clothing of the customer, and
   the identifying of the plurality of attributes includes identifying the group activity attribute relating to each of the plurality of customers by using a first attribute group including at least one of the age group, the distance attribute, the store visit time attribute, the store visit means attribute, or the clothing attribute, and one or more first determination conditions for determining customers who act in the groups of a plurality of people.
32. The program according to 31.,
   in which the plurality of attributes include a group attribute relating to the group, and
   the identifying of the plurality of attributes further includes identifying the group attribute relating to customers who act in the groups of a plurality of people.
33. The program according to 32.,
   in which the group attribute includes the group type, and
   the identifying of the group attribute includes identifying the group type associated with the at least one first determination condition satisfied by the customers who act in the groups of a plurality of people as the group type of the customers who act in the groups of a plurality of people by using group type definition information that associates the group type with the at least one first determination condition.
34. The program according to any one of 31. to 33.,
   in which each of the one or more first determination conditions includes at least one of:
   a fact that the age groups are common to each other or differ within a predetermined range;
   a fact that the inter-customer distance at a store visit time is within a predetermined first distance;
   a time difference between times of entering the facility is within a predetermined second time;
   a fact that the inter-customer distance at the store visit time with a child whose age group is equal to or less than a predetermined age threshold is within a predetermined second distance;
   a fact that a time difference between the store visit times with the child is within a predetermined fourth time; or
   a fact that a proximity activity time obtained by adding up a time length in which the inter-customer distance is within a predetermined third distance over a period of staying in the facility is equal to or more than a fifth time which is a predetermined time length.
35. The program according to any one of 31. to 34.,
   in which the store visit means attribute includes the store visit means identification information regarding the store visit means that is capable of being used by a plurality of people at the same time, and
   each of the one or more first determination conditions includes at least one of
   a fact that a time difference between times of entering a site of the facility by using the store visit means with different store visit means identification information for identifying the store visit means is within a predetermined third time, or
   a fact that in a case where the plurality of people visit a store using the store visit means that is capable of being used by the plurality of people at the same time, the plurality of people visit the store using the store visit means with common store visit means identification information.
36. The program according to any one of 31. to 35.,
   in which the clothing attribute includes a first clothing attribute relating to a type of the clothing,
   the first clothing attribute includes clothing type identification information for identifying clothing belonging to a predetermined type of clothing, and
   each of the one or more first determination conditions includes at least one of
   a fact that the type of the clothing is common, or
   a fact that the clothing type identification information is common.
37. The program according to 36.,
   in which the clothing attribute further includes one or more of a second clothing attribute relating to a color of the clothing or a third clothing attribute relating to a pattern of the clothing, and
   the identifying of the plurality of attributes includes
   one or more of identifying the type of the clothing of each of the plurality of customers,
   identifying a color of the clothing of each of the plurality of customers, or
   identifying a pattern of the clothing of each of the plurality of customers, and
   identifying the clothing type identification information by using one or more of the first clothing attribute, the second clothing attribute, or the third clothing attribute and a clothing type identification condition for identifying clothing belonging to a predetermined type of clothing.
38. The program according to 37.,
   in which the clothing type identification condition is defined using clothing similarity indicating a degree of similarity of the clothing and a predetermined identification threshold, and
   the clothing similarity is obtained using the similarity of one or more of the second clothing attribute or the third clothing attribute.
39. The program according to any one of 30. to 3.,
   in which the plurality of attributes further include at least one of a payment attribute indicating that payment for a product is performed in the facility and a baggage attribute relating to baggage carried by the customer, and
   the identifying of the plurality of attributes includes identifying the non-purchase attribute relating to a customer, who does not purchase a product in the facility, among the plurality of customers by using a second attribute group including at least one of the payment attribute or the baggage attribute and one or more second determination conditions for determining the customer who does not purchase a product in the facility.
40. The program according to 39.,
   in which the baggage attribute includes one or more of a first baggage attribute, a second baggage attribute, or a third baggage attribute relating to each of a color, a pattern, a size, and a shape of the baggage, and
   the second determination condition includes at least one of
   a fact that a payment device in the facility is not used, or
   a fact that the baggage attribute relating to the customer who exits the facility is not a purchased baggage predetermined using one or more of the first baggage attribute, the second baggage attribute, or the third baggage attribute.
41. The program according to 40.,
   in which the identifying of the plurality of attributes further includes identifying the payment attribute using a third determination condition for determining whether the customer uses the payment device.
42. The program according to any one of 29. to 41.,
   in which the plurality of attributes further include a utilization equipment attribute relating to equipment of the facility used by the customer.
43. A recording medium that stores a program for causing one or more computers to execute processing of:
   processing a video relating to a facility to identify a plurality of attributes relating to each of a plurality of customers; and
   performing statistical processing relating to the plurality of customers by using at least one attribute included in the identified plurality of attributes,
   in which the at least one attribute includes a group activity attribute relating to customers who act in groups of a plurality of people.
44. The recording medium that stores a program according to 43.,
   in which the attribute further includes a non-purchase attribute relating to a customer who does not purchase a product in the facility.
45. The recording medium that stores a program according to 43. or 44.,
   in which the plurality of attributes further include at least one of an age group of the customer, a distance attribute relating to an inter-customer distance which is a distance between the customer and another customer, a store visit time attribute relating to a store visit time of the customer, a store visit means attribute relating to a store visit means of the customer, or a clothing attribute relating to clothing of the customer, and
   the identifying of the plurality of attributes includes identifying the group activity attribute relating to each of the plurality of customers by using a first attribute group including at least one of the age group, the distance attribute, the store visit time attribute, the store visit means attribute, or the clothing attribute, and one or more first determination conditions for determining customers who act in the groups of a plurality of people.
46. The recording medium that stores a program according to 45.,
   in which the plurality of attributes include a group attribute relating to the group, and
   the identifying of the plurality of attributes further includes identifying the group attribute relating to customers who act in the groups of a plurality of people.
47. The recording medium that stores a program according to 46.,
   in which the group attribute includes the group type, and
   the identifying of the group attribute includes identifying the group type associated with the at least one first determination condition satisfied by the customers who act in the groups of a plurality of people as the group type of the customers who act in the groups of a plurality of people by using group type definition information that associates the group type with the at least one first determination condition.
48. The recording medium that stores a program according to any one of 45. to 47.,
   in which each of the one or more first determination conditions includes at least one of:
   a fact that the age groups are common to each other or differ within a predetermined range;
   a fact that the inter-customer distance at a store visit time is within a predetermined first distance;
   a time difference between times of entering the facility is within a predetermined second time;
   a fact that the inter-customer distance at the store visit time with a child whose age group is equal to or less than a predetermined age threshold is within a predetermined second distance;
   a fact that a time difference between the store visit times with the child is within a predetermined fourth time; or
   a fact that a proximity activity time obtained by adding up a time length in which the inter-customer distance is within a predetermined third distance over a period of staying in the facility is equal to or more than a fifth time which is a predetermined time length.
49. The recording medium that stores a program according to any one of 45. to 48.,
   in which the store visit means attribute includes the store visit means identification information regarding the store visit means that is capable of being used by a plurality of people at the same time, and
   each of the one or more first determination conditions includes at least one of
   a fact that a time difference between times of entering a site of the facility by using the store visit means with different store visit means identification information for identifying the store visit means is within a predetermined third time, or
   a fact that in a case where the plurality of people visit a store using the store visit means that is capable of being used by the plurality of people at the same time, the plurality of people visit the store using the store visit means with common store visit means identification information.
50. The recording medium that stores a program according to any one of 45. to 49.,
   in which the clothing attribute includes a first clothing attribute relating to a type of the clothing,
   the first clothing attribute includes clothing type identification information for identifying clothing belonging to a predetermined type of clothing, and
   each of the one or more first determination conditions includes at least one of
   a fact that the type of the clothing is common, or
   a fact that the clothing type identification information is common.
51. The recording medium that stores a program according to 50.,
   in which the clothing attribute further includes one or more of a second clothing attribute relating to a color of the clothing or a third clothing attribute relating to a pattern of the clothing, and
   the identifying of the plurality of attributes includes
   one or more of identifying the type of the clothing of each of the plurality of customers,
   identifying a color of the clothing of each of the plurality of customers, or
   identifying a pattern of the clothing of each of the plurality of customers, and
   identifying the clothing type identification information by using one or more of the first clothing attribute, the second clothing attribute, or the third clothing attribute and a clothing type identification condition for identifying clothing belonging to a predetermined type of clothing.
52. The recording medium that stores a program according to 51.,
   in which the clothing type identification condition is defined using clothing similarity indicating a degree of similarity of the clothing and a predetermined identification threshold, and
   the clothing similarity is obtained using the similarity of one or more of the second clothing attribute or the third clothing attribute.
53. The recording medium that stores a program according to any one of 44. to 52.,
   in which the plurality of attributes further include at least one of a payment attribute indicating that payment for a product is performed in the facility and a baggage attribute relating to baggage carried by the customer, and
   the identifying of the plurality of attributes includes identifying the non-purchase attribute relating to a customer, who does not purchase a product in the facility, among the plurality of customers by using a second attribute group including at least one of the payment attribute or the baggage attribute and one or more second determination conditions for determining the customer who does not purchase a product in the facility.
54. The recording medium that stores a program according to 53.,
   in which the baggage attribute includes one or more of a first baggage attribute, a second baggage attribute, or a third baggage attribute relating to each of a color, a pattern, a size, and a shape of the baggage, and
   the second determination condition includes at least one of
   a fact that a payment device in the facility is not used, or
   a fact that the baggage attribute relating to the customer who exits the facility is not a purchased baggage predetermined using one or more of the first baggage attribute, the second baggage attribute, or the third baggage attribute.
55. The recording medium that stores a program according to 54.,
   in which the identifying of the plurality of attributes further includes identifying the payment attribute using a third determination condition for determining whether the customer uses the payment device.
56. The recording medium that stores a program according to any one of 43. to 55.,
   in which the plurality of attributes further include a utilization equipment attribute relating to equipment of the facility used by the customer.

This application is based upon and claims the benefit of priority from Japanese patent application No. 2023-022231, filed on Feb. 16, 2023, the disclosure of which is incorporated herein in its entirety by reference.

### REFERENCE SIGNS LIST

100 information processing system
101_1 to 101_M imaging device
102 video storage device
104 statistical processing device
111 analysis unit
131 video acquisition unit
132, 232, 332 analysis unit
133 object detection unit
134, 234, 334 attribute identification unit
134a, 234a group identification unit
134b, 334b non-purchase identification unit
134c utilization equipment identification unit
135 attribute information storage unit
136 attribute transmission unit
141 selection reception unit
142 attribute information acquisition unit
143 statistical processing unit
144 output unit
145 output control unit
234d group attribute identification unit
234d1 group type identification unit
234e age group identification unit
234f distance attribute identification unit
234h store visit means attribute identification unit
234i first clothing identification unit
234 second clothing identification unit
234k third clothing identification unit
234l clothing type identification unit
334m payment identification unit
334n first baggage identification unit
334o second baggage identification unit
334p third baggage identification unit

What is claimed is:

1. An information processing system comprising:
at least one memory configured to store instructions; and
at least one processor configured to execute the instructions to:
identify a plurality of attributes relating to each of a plurality of customers by processing a video relating to a facility; and
perform statistical processing relating to the plurality of customers by using at least one attribute included in the identified plurality of attributes,
wherein the at least one attribute includes a group activity attribute relating to customers who act in groups of a plurality of people.

2. The information processing system according to claim 1,
wherein the attribute further includes a non-purchase attribute relating to a customer who does not purchase a product in the facility.

3. The information processing system according to claim 1,
wherein the plurality of attributes further include at least one of an age group of the customer, a distance attribute relating to an inter-customer distance which is a distance between the customer and another customer, a store visit time attribute relating to a store visit time of the customer, a store visit means attribute relating to a store visit means of the customer, or a clothing attribute relating to clothing of the customer, and
processing the video includes identifying the group activity attribute relating to each of the plurality of customers by using a first attribute group including at least one of the age group, the distance attribute, the store visit time attribute, the store visit means attribute, or the clothing attribute, and one or more first determination conditions for determining customers who act in the groups of a plurality of people.

4. The information processing system according to claim 3,
wherein the plurality of attributes include a group attribute relating to the group, processing the video further includes identifying the group attribute relating to the customers who act in groups of a plurality of people,
the group attribute includes the group type, and
identifying the group activity attribute includes identifying the group type associated with the at least one first determination condition satisfied by the customers who act in the groups of a plurality of people as the group type of the customers who act in the groups of a plurality of people by using group type definition information that associates the group type with the at least one first determination condition.

5. The information processing system according to claim 3,
wherein each of the one or more first determination conditions includes at least one of:
a fact that the age groups are common to each other or differ within a predetermined range;
a fact that the inter-customer distance at a store visit time is within a predetermined first distance;
a time difference between times of entering the facility is within a predetermined second time;
a fact that the inter-customer distance at the store visit time with a child whose age group is equal to or less than a predetermined age threshold is within a predetermined second distance;
a fact that a time difference between the store visit times with the child is within a predetermined fourth time; or
a fact that a proximity activity time obtained by adding up a time length in which the inter-customer distance is within a predetermined third distance over a period of staying in the facility is equal to or more than a fifth time which is a predetermined time length.

6. The information processing system according to claim 3,
wherein the store visit means attribute includes the store visit means identification information regarding the store visit means that is capable of being used by a plurality of people at the same time, and
each of the one or more first determination conditions includes at least one of
a fact that a time difference between times of entering a site of the facility by using the store visit means with different store visit means identification information for identifying the store visit means is within a predetermined third time, or
a fact that in a case where the plurality of people visit a store using the store visit means that is capable of being used by the plurality of people at the same time, the plurality of people visit the store using the store visit means with common store visit means identification information,
the clothing attribute includes a first clothing attribute relating to a type of the clothing,
the first clothing attribute includes clothing type identification information for identifying clothing belonging to a predetermined type of clothing, and
each of the one or more first determination conditions includes at least one of
a fact that the type of the clothing is common, or
a fact that the clothing type identification information is common.

7. The information processing system according to claim 2,
wherein the plurality of attributes further include at least one of a payment attribute indicating that payment for a product is performed in the facility and a baggage attribute relating to baggage carried by the customer, and
identifying the group activity attribute includes a identifying the non-purchase attribute relating to a customer, who does not purchase a product in the facility, among the plurality of customers by using a second attribute group including at least one of the payment attribute or the baggage attribute and one or more second determination conditions for determining the customer who does not purchase a product in the facility.

8. The information processing system according to claim 7,
wherein the baggage attribute includes one or more of a first baggage attribute, a second baggage attribute, or a third baggage attribute relating to each of a color, a pattern, a size, and a shape of the baggage, and
the second determination condition includes at least one of
a fact that a payment device in the facility is not used, or
a fact that the baggage attribute relating to the customer who exits the facility is not a purchased baggage predetermined using one or more of the first baggage attribute, the second baggage attribute, or the third baggage attribute.

9. An information processing method comprising causing one or more computers to:
identify a plurality of attributes relating to each of a plurality of customers by processing a video relating to a facility; and
perform statistical processing relating to the plurality of customers by using at least one attribute included in the identified plurality of attributes,
wherein the at least one attribute includes a group activity attribute relating to customers who act in groups of a plurality of people.

10. A non-transitory computer readable medium that stores a program for causing one or more computers to execute processing of:
identify a plurality of attributes relating to each of a plurality of customers by processing a video relating to a facility; and
performing statistical processing relating to the plurality of customers by using at least one attribute included in the identified plurality of attributes,
wherein the at least one attribute includes a group activity attribute relating to customers who act in groups of a plurality of people.
